(19) United States
(12) Patent Application Publication
(10) Pub. No.: US 2014/0115470 A1
(43) Pub. Date: Apr. 24, 2014

(54) USER INTERFACE FOR AUDIO EDITING

(71) Applicant: APPLE INC., Cupertino, CA (US)

(72) Inventors: Brian Everett Meaney, San Francisco, CA (US); Ken Matsuda, Sunnyvale, CA (US); Matt Diephouse, Columbus, OH (US); David Chen, Cupertino, CA (US); Jordan McCommons, San Francisco, CA (US)

(73) Assignee: APPLE INC., Cupertino, CA (US)

(21) Appl. No.: 13/657,802

(22) Filed: Oct. 22, 2012

(51) Int. Cl. G06F 3/048

(52) U.S. Cl. 715/719

(57) ABSTRACT

Computer-implemented methods, computer-readable media, and computer systems implemented to provide user interfaces for audio editing. An item of digital multimedia content that includes video content and audio content that is synchronized with the video content is displayed in a user interface. The audio content includes audio from multiple audio components. Multiple audio objects, each representing an audio component of the multiple audio components, are displayed in the user interface. In response to detecting an input to an audio object, at least one feature of an audio component that the audio object represents is modified while maintaining a synchronization of the video and audio contents.

### TECHNICAL FIELD

This disclosure relates generally to editing digital multimedia content.

### BACKGROUND

Digital multimedia content, for example, audio, video, images, and the like, can be captured using media capturing devices, such as, microphones, video cameras, and the like. The content can be transferred from the capturing devices to computer systems and viewed or edited (or both) using one or more computer software applications. Digital multimedia content can include both audio content and video content. For example, a video camera can capture video and audio of two persons having a conversation. The audio and video can be edited with a digital multimedia editing application. Some editing applications provide a user interface for displaying video and audio objects representing video and audio content. When audio objects are edited by the user, the audio objects may get out of sync with the video objects making the editing process difficult.

### SUMMARY

This disclosure describes technologies relating to editing audio in digital multimedia using user interfaces. In some implementations, a digital multimedia editing application provides lanes for displaying video and audio objects (e.g., a conversation between actors) as well as effects (FX) objects and a music sound track. Each object in a lane corresponds to a video, audio or effect file stored in the computer system. An audio object may represent a multichannel audio signal (e.g., a stereo or surround mix). One or more user interfaces provided by the editing application allows a user to visually separate the audio components from the multichannel audio signal and to edit those components independently by, for example, adjusting volume, equalizing, panning or applying effects. These editing operations are performed on audio objects while maintaining synchronization with corresponding video objects in a video lane.

One innovative aspect of the subject matter described here can be implemented as a computer-implemented method. In a first portion of a user interface, an item of digital multimedia content that includes video content and audio content that is synchronized with the video content is displayed. The audio content includes audio from multiple audio channels. In a second portion of the user interface, multiple audio objects, each representing an audio component of the multiple audio components, are displayed. An input to an audio object of the multiple audio objects is detected. In response to detecting the input of the audio object, at least one feature of an audio component that the audio object represents is modified while maintaining a synchronization of the video content and the audio content.

This, and other aspects, can include one or more of the following features. The item of digital multimedia content can be displayed in the second portion of the user interface and adjacent to the multiple audio objects. The item of digital multimedia content can span a duration. The item of digital multimedia content can be displayed as a video object of a dimension that corresponds to the duration of the item of digital multimedia content. An object of the multiple audio objects can be displayed with the dimension that corresponds to the duration of the item of digital multimedia content. Input to extend the dimension of the audio object of the multiple audio objects beyond the dimensions can be detected. In response to detecting the input, an audio component that the audio object represents can be extended beyond the duration of the item of digital multimedia content. Each audio component can be a monophonic audio channel. The multiple monophonic audio channels can be organized into one or more stereophonic audio components in response to input. Each audio component of stereophonic sound can include two monophonic audio channels. A feature of a stereophonic audio component can be modified in response to input. The audio content can be modified according to the modified feature of the stereophonic audio component. In a third portion of the user interface, another multiple audio objects can be displayed in response to input. Each of the other multiple audio objects can represent the audio component of the multiple audio components. The multiple audio objects can be organized into a single object representing the audio content in response to input. The single audio object can be displayed in the second portion of the user interface instead of the multiple audio objects. To modify at least one feature of an audio component that the audio object represents in response to detecting the input of the audio object, a selection of a portion of the audio object can be detected. The portion can span a duration of time. In response to detecting the selection of the portion, at least one feature of the audio component that the portion of the object represents can be modified. The input can include input to silence audio in the selected portion.

Another innovative aspect of the subject matter described here can be implemented as a computer-readable medium storing instructions executable by data processing apparatus to perform operations. The operations include displaying an item of digital multimedia content that includes synchronized video content and audio content in a user interface. The video content includes multiple frames and the audio content includes audio from multiple audio channels. The operations include displaying, in the user interface, a subset of the multiple frames included in the video content. The operations include displaying, in the user interface, multiple audio objects that correspond to the multiple audio components. The multiple audio components represent a portion of audio content included in the multiple audio channels and synchronized with the subset of the multiple frames. The operations include detecting a selection of an audio object of the multiple audio objects, and, in response, modifying a feature of an audio component that the audio object represents.

This, and other aspects, can include one or more of the following features. The feature can include a decibel level of the audio component. Modifying the feature of the audio component can include decreasing the decibel level of the audio component. The operations can include displaying a name of the audio component that the audio object represents in the second portion of the user interface, and displaying a modified name of the audio component instead of the name in response to input to modify the name of the audio component. Detecting the selection of the audio object of the multiple audio objects can include detecting a selection of a portion of the audio object of the multiple audio objects. Modifying the feature of the audio component in the portion of the audio object can include disabling all features of a portion of the audio component represented by the portion of the audio object. The operations can include detecting a selection of a portion of the audio object of the multiple audio objects, displaying a border around the portion of the audio object, displaying a horizontal line within the portion at a position that represents a level of the feature, and modifying the feature of the audio component in the portion in response to and according to a modification of the position of the horizontal line. Each audio component can be a monophonic audio channel. The operations can include displaying a first option to organize the multiple monophonic audio channels into one or more stereophonic audio components and a second option to organize the multiple monophonic audio channels into a single component, detecting a selection of either the first option or the second option, and organizing the multiple monophonic audio channels into either one or more stereophonic audio component or the single component based on the selection. Displaying the multiple audio objects in the user interface can include displaying the multiple audio objects below the subset of the multiple frames. A horizontal dimension of each audio object of the multiple audio objects can be substantially equal to a horizontal dimension of a video object in which the subset of the multiple frames is displayed. The operations can include displaying multiple effects objects in the user interface. Each effects object can represent a predefined modification that is applicable to one or more effects in an audio component. The operations can include detecting a selection of a particular effects object that represents a particular predefined modification and a particular audio object that represents a particular audio component. The operations can include modifying one or more features in the particular audio component according to the predefined modification. Modifying a feature of an audio component that the audio object represents can include displaying a modification to the feature as an animation within the audio object. The operations can include receiving input to assign an audio type to an audio component, and assigning the audio type to the audio component in response to the input. The audio type can include at least one of a dialogue, music, or an effect.

A further innovative aspect of the subject matter described here can be implemented as a system that includes one or more data processing apparatus and a computer-readable medium storing instructions executable by the one or more data processing apparatus to perform operations. The operations include displaying, in a user interface, a thumbnail video object that represents a video portion of an item of digital multimedia content. The operations include displaying, in the user interface, multiple audio objects representing multiple audio components included in an audio portion of the item of digital multimedia content. The operations include detecting, in the user interface, a selection of an audio object of the multiple audio objects. The operations include, in response to detecting the selection, modifying a feature of an audio component that the audio object represents, and modifying the audio portion of the item of digital multimedia content according to the modified feature of the audio component.

This, and other aspects, can include one or more of the following features. The operations can include assigning an audio type to each audio component in response to receiving input. Modifying the feature of the audio component that the object represents can include displaying multiple audio types in the user interface, and displaying multiple selectable controls in the user interface. Each selectable control can be displayed adjacent a respective audio type. Modifying the feature can include detecting a selection of a particular selectable control displayed adjacent a particular audio type, and disabling a feature associated with the particular audio type in response to detecting the selection.

An additional innovative aspect of the subject matter described here can be implemented as a computer-implemented method. In a user interface, a first item of digital multimedia content that includes video content received from a first viewing position and audio content received from multiple audio components is displayed. The audio content is synchronized with the video content. In the user interface, a second item of digital multimedia content that includes the video content received from a second viewing position and the audio content received from multiple second audio components is displayed. In response to detecting input to modify a feature of either a first audio component or a second audio component, the audio content received from the multiple first audio components or from the multiple second audio components is modified.

This, and other aspects, can include one or more of the following features. A selection of the first item of digital multimedia content can be detected. In response to detecting the first item of digital multimedia content, the multiple first audio components can be displayed, and the multiple second audio components can be hidden from display. The video content can include multiple frames. A selection of a portion of the first item of digital multimedia content that includes video content received from the first viewing position can be detected. A subset of the multiple frames can be displayed. The subset can correspond to the portion of the first item of digital multimedia content that includes video content received from the first viewing position. Multiple audio objects, each of which represents a portion of a first audio component that is synchronized with the portion of the first item of digital multimedia content that includes video content received from the first viewing position can be displayed.

The details of one or more implementations of a user interface for audio editing are set forth in the accompanying drawings and the description below. Other features, aspects, and advantages of editing the audio will become apparent from the description, the drawings, and the claims.

### BRIEF DESCRIPTION OF THE DRAWINGS

FIG. 1 is an example of a computer system for managing items of digital multimedia content.

FIGS. 2A-2G are examples of user interfaces that present audio components included in items of digital multimedia content as editable objects.

FIGS. 3A-3F are examples of user interfaces that present audio components included in items of digital multimedia content as editable objects.

FIGS. 4A-4C are examples of user interfaces for editing objects that represent audio components included in items of digital multimedia content.

FIGS. 5A-5C are examples of user interfaces for applying effects to audio components.

FIGS. 6A and 6B are examples of user interfaces for applying roles to audio components.

FIG. 7 is an example of a user interface for modifying the metadata of audio components.

FIGS. 8A-8C are examples of user interfaces for editing audio content included in items of digital multimedia content.

FIG. 9 is a flowchart of an example process for modifying a feature of an audio component included in an item of digital multimedia content.

FIG. 10 is a flowchart of an example process for modifying a feature of an audio component included in an item of digital multimedia content.

FIG. 11 is a flowchart of an example process for modifying a feature of an audio component included in an item of digital multimedia content.

FIGS. 12A-12C are examples of user interfaces for editing audio content included in items of digital multimedia content captured from two viewing positions.

FIG. 13 is a flowchart of an example process for modifying a feature of an audio component included in an item of digital multimedia content captured from two viewing positions.

FIG. 14 is a block diagram of an exemplary architecture for implementing the features and operations of FIGS. 1-13.

Like reference symbols in the various drawings indicate like elements.

### DETAILED DESCRIPTION

This disclosure generally describes computer-implemented methods, computer software, and computer systems for editing items of digital multimedia content using user interfaces. In general, an item of digital multimedia content can include at least two different types of digital multimedia content synchronized with each other. The types of digital multimedia content can include video content, audio content, images, text, and the like. For example, an item of digital multimedia content can include frames of video content that visually represent two persons having a conversation and corresponding audio content that can include each person's voice and any ambient noises. The video content and the audio content are synchronized. For example, the audio content that includes a person's voice corresponds to the person's lip movements in the video content. Each of the video content and the audio content in the item can be edited. For example, a brightness or contrast of the video content can be modified and background music can be added to the audio content. Digital multimedia content added by editing can be synchronized with digital multimedia content already included in the item.

In some implementations, an item of digital multimedia content can be presented in a user interface as one or more objects. For example, video content and audio content can be displayed in the user interface as respective video and audio objects. The audio content can include multiple components of audio. With reference to the example item of digital multimedia content described above, the video of the two persons having the conversation can be represented as a video object, for example, as one or more thumbnails. The voice of each of the two person's having the conversation can be an audio component which can also be displayed in the user interface as a respective audio object. Editing operations can be performed by providing inputs to the user interface which can include, for example, selecting, re-sizing, re-positioning the video objects or the audio objects (or both). As described below, an audio object represents an audio component. An audio component can include one or more audio channels. For example, an audio component can consist of a monophonic audio channel or stereophonic audio channels or a surround mix. Thus, an audio component can consist of two monophonic audio channels that collectively make up a stereophonic audio component.

This disclosure describes computer systems that present user interfaces which can enable authoring items of digital multimedia content by a user, and more particularly audio content included in the items. As described below, the computer systems can configure the user interfaces to provide a consolidated video/audio view that can allow an overall view of the video content and audio content included in the item of digital multimedia content. In addition, the computer systems can enable the user to individually edit either the video content or the audio content (or both) in the same consolidated video/audio view instead of in separate views. In the user interfaces, the computer systems can present the video content and multiple components of audio as respective selectable video and audio objects in a timeline that represents a duration of the item of digital multimedia content. Each object can be manipulated in context to the timeline without leaving the consolidated video/audio view. In this manner, the computer systems can present a consolidated video/audio view as video and audio objects that include both the video and audio contents, and enable editing of each object individually while maintaining synchronization between the video and audio content.

Examples of editing operations that a user can perform on the audio content, particularly, on each audio component, using the user interfaces include trimming start and end points of audio components, disabling or removing ranges within the audio components, adjusting volume or pan on individual audio components, adding and manipulating effects on individual audio components or all of the audio content (or both), understanding audio included in a component, enabling or disabling certain features for ranges of or all of audio components, and the like. As described below, each editing operation can be performed by selecting all or portions of an object that represents an audio component or the audio content.

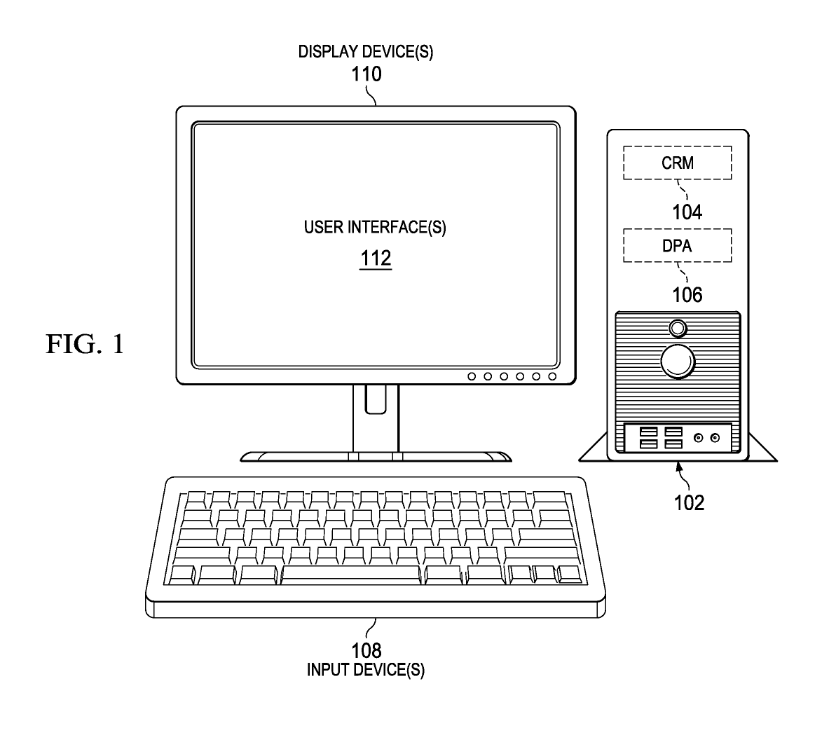

FIG. 1 is an example of a computer system 102 for managing items of digital multimedia content. The computer system 102 can include a computer-readable medium 104 storing instructions executable by data processing apparatus 106 to perform operations. The computer system 102 can be connected to one or more input devices 108 and one or more display devices 110. In the display devices 110, the computer system 102 can display one or more user interfaces 112, such as those described with reference to the following figures. A user of the computer system 102 can provide input to objects (for example, video objects, audio objects) representing items of digital multimedia content displayed in the user interfaces 112 using the input devices 108. For example, the computer system 102 can include a desktop computer, a laptop computer, a tablet computer, a smartphone, a personal digital assistant (PDA), and the like. A display device 110 can include a monitor, a retina display device, and the like. Input devices 108 can include a keyboard, a pointing device (for example, a mouse, a track ball, a stylus, and the like). Input devices 108 can also include microphones that can receive audio input. In some implementations, the computer system 102 can be implemented to include touchscreens that can both receive input (for example, touch input) and display output (for example, the user interfaces 112).

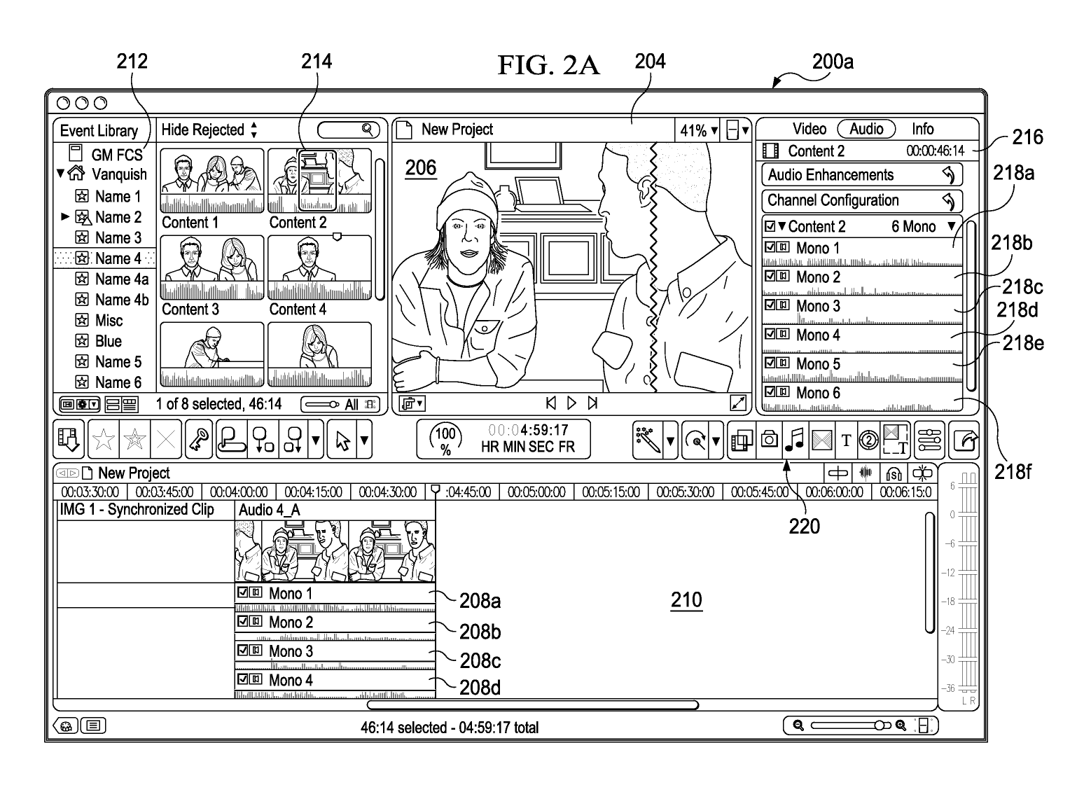

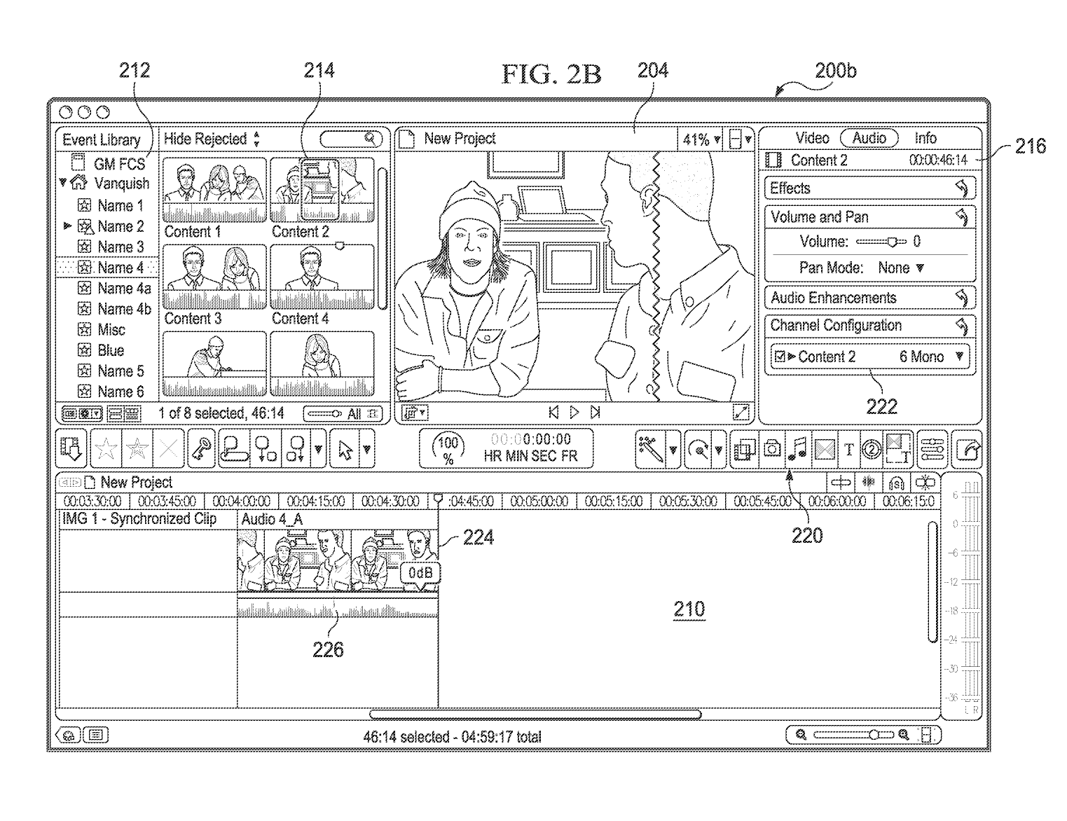

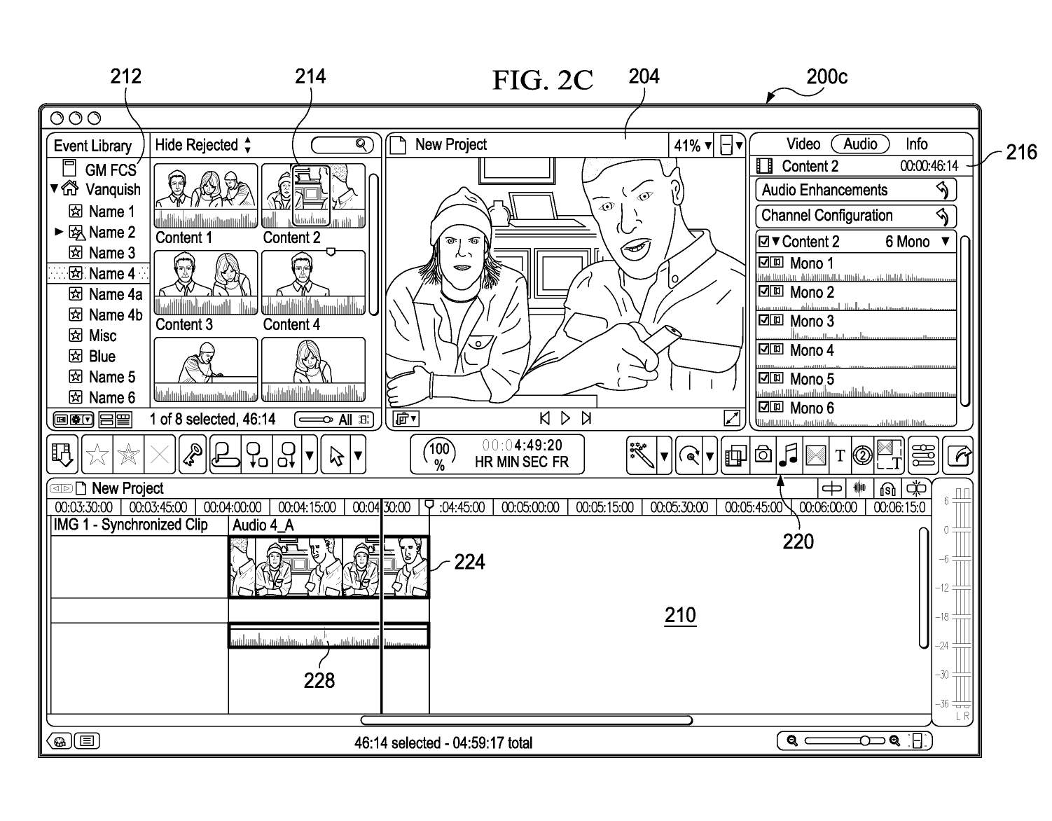

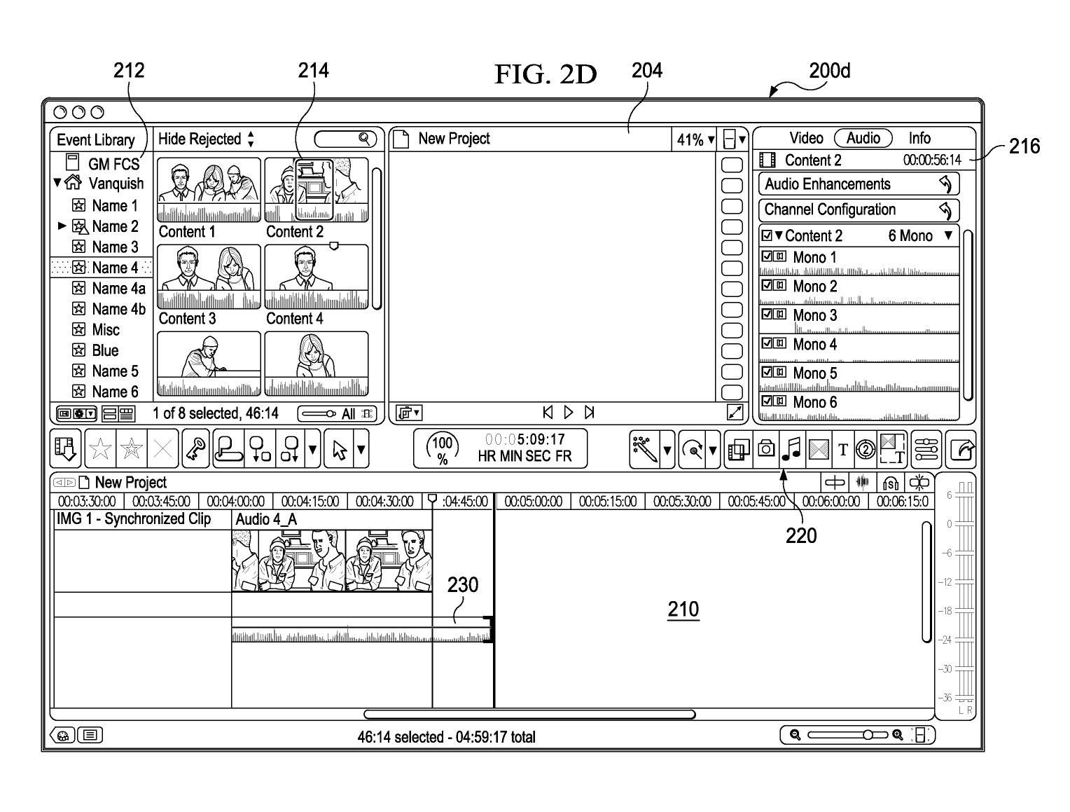

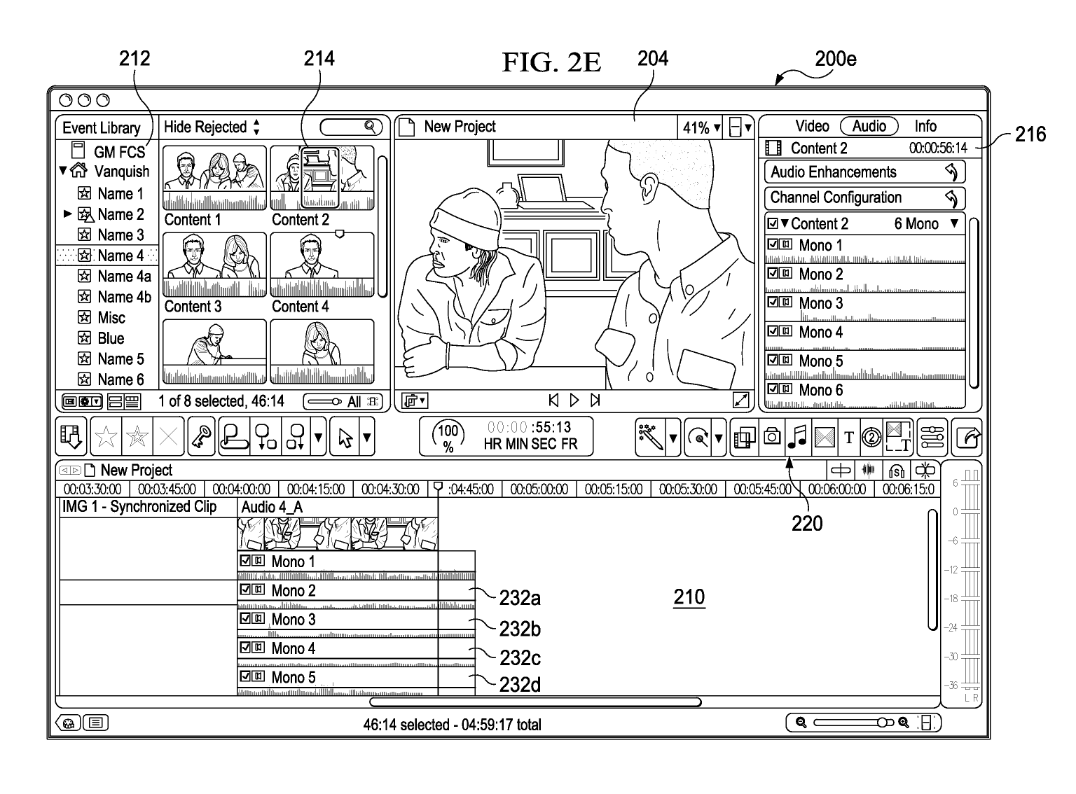

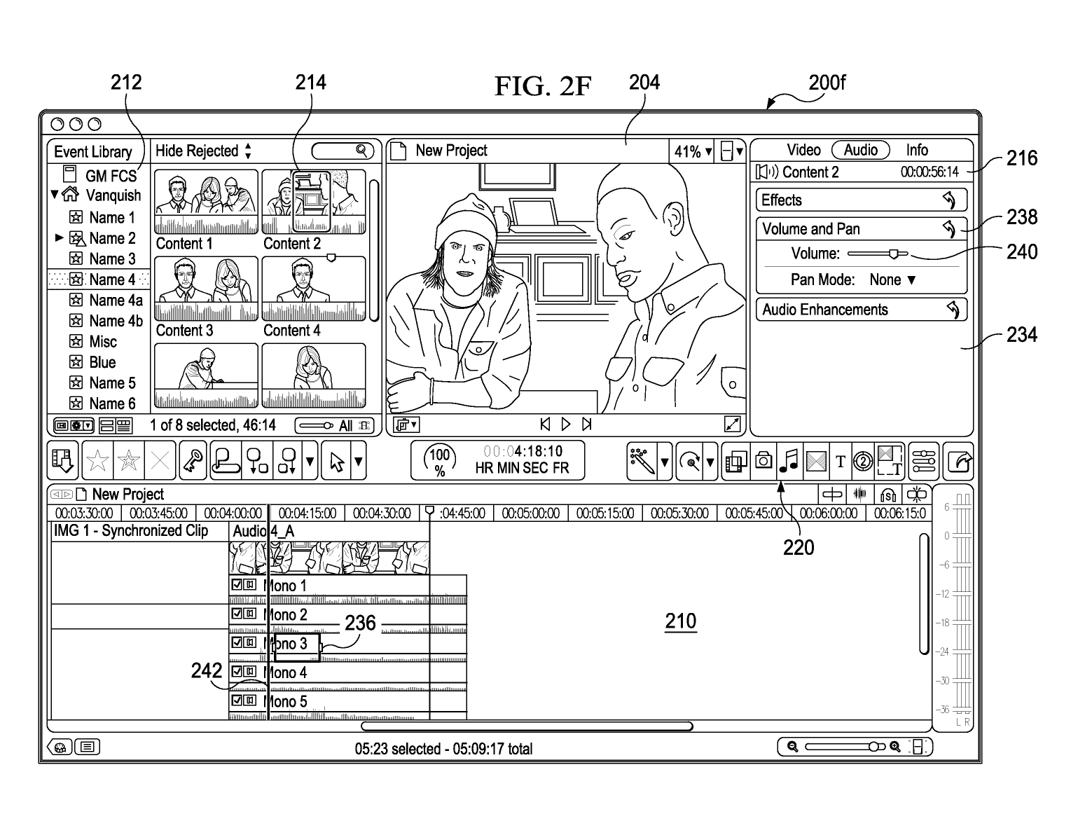

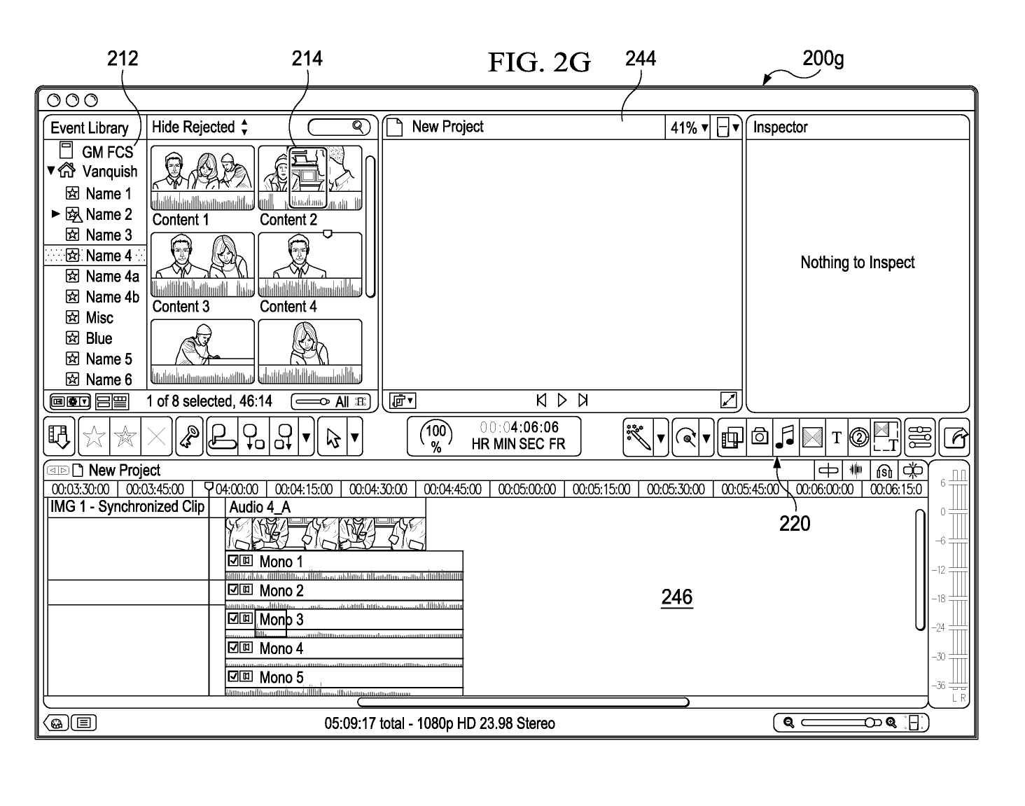

FIGS. 2A-2G are examples of user interfaces that present audio components included in items of digital multimedia content as editable objects. The computer system 102 can implement the user interfaces shown in FIGS. 2A-2G as computer-readable instructions stored on the computer-readable medium 104 and executed by the data processing apparatus 106. In some implementations, the computer system 102 can display the user interface 200a (FIG. 2A), and, in the user interface 200a, display both video content and audio content in one view as respective video objects and audio objects. In addition, the computer system 102 can enable a user to edit either the audio content or the video content (or both) by providing input to the user interface 200a, for example, as selections of all or portions of the respective video objects or the audio objects (or both).

The computer system 102 can display an item of digital multimedia content 206 in a first portion 204 of the user interface 200a, for example, a portion in which the item 206 can be played back. The item 206 can include video content, and audio content that is both synchronized with the video content and that includes audio from multiple audio components. In a second portion 210 of the user interface 200a, the computer system 102 can display multiple audio objects (for example, audio object 208a, audio object 208b, audio object 208c, audio object 208d), each representing an audio component of the multiple audio components. The second portion 210 can be a timeline portion that displays either the video content or the audio content (or both) chronologically. The computer system 102 can detect an input to an audio object (for example, audio object 208a) of the multiple audio objects. The input can be a selection of the audio object, for example, of a point in the audio object, a portion of the audio object, or the audio object in its entirety. In response to detecting the input to audio object 208a, the computer system 102 can modify at least one feature of an audio component that audio object 208a represents while maintaining a synchronization of the video content and the audio content.

For example, the item of digital multimedia content 206 can include video content that shows two persons having a conversation. The audio content included in the item 206 can include audio in multiple audio components, which include each person's voice in a respective audio component and an additional audio component (for example, background score, ambient noises, voice-overs, voices of persons off-camera, or the like). As FIG. 2A illustrates, the computer system 102 can show the video content in a video object in the first portion 204 of the user interface 200a and six audio objects representing the six monophonic audio components in the second portion 210 of the user interface 200a. If insufficient space is available to display all the audio objects representing audio components in the second portion 210, the computer system 102 can include a scroll bar using which a user can scroll the second portion 210 to view all of the audio objects.

Either in default implementations or in response to input, the computer system 102 can display the item of digital multimedia content in the second portion 210 of the user interface 200a, for example, adjacent to the multiple audio objects 208a-208d. The input can include, for example, a drag-and-drop of the video object representing item 206 in the user interface 200a, a selection of a key on the keyboard, voice input, or the like. In some implementations, the computer system 102 can display the item of digital multimedia content as a rectangular video object having a horizontal dimension that corresponds to a duration of playback of the item. The computer system 102 can display each audio component, which spans a duration equal to the duration of playback, as a respective rectangular audio object having the same horizontal dimension as the item.

In some implementations, the computer system 102 can organize (for example, reconfigure) the multiple audio objects representing the multiple audio channels into fewer audio objects. With reference to the example described above, the computer system 102 can receive input to organize (for example, reconfigure) the six monophonic audio channels into a single audio component that represents the audio content of the item of digital multimedia content. As shown in user interface 200b (FIG. 2B), the computer system 102 can receive input (for example, a selection of a toggle button control) to display one audio object representing the audio content included in the item 206 instead six audio objects representing six monophonic audio channels included in the audio content. In response, the computer system 102 can display a single audio object 226 in the second portion 210 representing the audio content. In this manner, the computer system 102 can enable a user to toggle between displaying six audio objects representing monophonic audio channels or one audio object representing all of the audio content.

As shown in user interface 200b (FIG. 2B), the computer system 102 can display the video object 224 that represents the item of digital multimedia content as abutting the audio object 226 that represents the audio content to visually communicate a synchronization between the video content and the audio content included in the item. In response to receiving input (for example, a selection or a drag-and-drop input), the computer system 102 can display the audio content as an audio object 228 (FIG. 2C) that is separate from the video object 224 that represents the item. Despite the separation, the computer system 102 can maintain a synchronization of the video content and the audio content represented by the video object 224 and the audio object 228, respectively. To visually communicate the synchronization, in some implementations, the computer system 102 can align vertical edges of the video object 224 and the audio object 228 along the same vertical line.

In some implementations, the computer system 102 can extend an audio component beyond a duration of the item of digital video content. For example, the computer system 102 can detect a selection of an edge (such as, the right edge) of an audio object that represents an audio component, and can further detect a dragging of the selected edge away from the audio object (i.e., toward the right). As shown in user interface 200d (FIG. 2D), the computer system 102 can responsively extend the dimension of the audio object 230 beyond the dimension of the video object that represents the item of digital multimedia content. In addition, the computer system 102 can extend the audio component that the audio object represents beyond the duration of the item of digital multimedia content. The computer system 102 can similarly extend all the audio components beyond the duration of the item of digital multimedia content in response to input, as represented by the audio objects 232a, 232b, 232c, and 232b shown in user interface 200e (FIG. 2E).

As described above, the computer system 102 can modify at least one feature of an audio component that an audio object (for example, the audio object 232b) represents while maintaining a synchronization of the video content and the audio content. To do so, for example, the computer system 102 can detect a selection of the audio object 232b in the user interface 200e. In response to detecting the selection, the computer system 102 can cause a panel 238 to be displayed in the portion 234 of the user interface 200f (FIG. 2F). In the panel 238, the computer system 102 can display features (for example, a volume, a pan, audio enhancements, and the like) of the audio component represented by the audio object 232b. For each feature, the computer system 102 can display a respective control using which the feature can be modified. For example, for the volume feature, the computer system 102 can display a slider bar control 240 that a user can control using the input devices to increase or decrease a volume of the audio component represented by the audio object 232b shown in FIG. 2E. Upon determining a feature of the audio component represented by the audio object 232b has been modified, the computer system 102 can modify the entire audio content to reflect the modification to the audio component. For example, if the audio content includes three monophonic audio channels—a first channel being a first person's voice, a second channel being a second person's voice, and a third channel being ambient noise—then, if a volume of the third channel is decreased to zero, then the entire audio content is modified to include only the voices of the two persons with no ambient noise. Thus, using controls displayed in the panel 238, a user can modify one or more features of one or more audio components to modify the audio content included in the item of digital multimedia content.

In some implementations, the computer system 102 can enable a user to modify features of an audio component by providing input to an audio object that represents the audio component. For example, within the audio object 232b, the computer system 102 can display a horizontal line from the left edge to the right edge of the object 232b. The position of the line within the audio object 232b can represent a level of a feature of the audio component. If the feature is decibel level, for example, then the level can be a minimum decibel level if the horizontal line is positioned near the bottom edge and a maximum decibel level if positioned near the top edge. The computer system 102 can enable a user to adjust the position of the horizontal line using the input devices, and thereby modify the feature of the audio component. To modify the feature of the entire audio component, the user can select the audio object 232b, and then select and move the horizontal line to adjust the feature of the audio component. For example, to decrease the decibel level of the entire audio component, the user can lower the position of the horizontal line displayed within the object audio 232b.

Alternatively, or in addition, the computer system 102 can modify the feature of a segment of the audio component. To do so, the computer system 102 can detect a selection of a portion of the audio object that spans a duration of time. In response to detecting the portion, the computer system 102 can modify at least one feature of the audio component that the portion of the object represents. For example, the user can select a portion 236 (FIG. 2F) of the audio object, for example, by selecting a first point and then a second, different point within the object or by performing a drag operation from the first point to the second point. In response, the computer system 102 can display a border surrounding the selected portion 236. The selected portion can represent a segment of the audio component that has a start time corresponding to the first point and an end time corresponding to the second point. The user can adjust the position of the horizontal line within the portion 236 resulting in a modification to the feature only within the segment of the audio component represented by the portion 236, i.e., the segment between the start time and the end time described above. For example, if the user adjusted the position to the bottom edge of the audio object, the computer system 102 can recognize the adjustment as an input to silence audio in the segment between the start time and the end time. In some implementations, the user can provide input to disable one or more or all features in the segment represented by the portion 236 in response to which the computer system 102 can disable the one or more features in the segment between the start time and the end time.

In some implementations, the computer system 102 can receive input to playback the modified audio component or the audio component modified to reflect the modified audio component. The computer system 102 can playback the audio in only the audio component or the entire audio content that includes all the audio components. In addition, the computer system 102 can display a vertical line 242 that runs across the video object that represents the item of digital multimedia content and the multiple audio objects. The position of the vertical line on the audio object can correspond to a beginning of a portion of the audio component that has been modified. As the modified audio component plays back, the computer system 102 can cause the vertical line to move horizontally across the audio object until the end of the playback. When the playback ends, the computer system 102 can display the vertical line at a position on the audio object that corresponds to the end of the portion of the modified audio component. As shown in user interface 200g (FIG. 2G), when the computer system 102 receives input to de-select the item of digital multimedia content, then the item hides the item from display as represented by the blank portion 244 in the user interface 200g. The computer system 102 also hides from display the panel that includes the controls to modify features shown in FIG. 2F.

Returning to FIG. 2A, the computer system 102 can display additional information about the item of digital multimedia content 206 in the user interface 200a. For example, the computer system 102 can display a name of a file under which the item 206 is stored, a folder in which the file is stored, and the like, in a hierarchical structure in a fourth portion 212 of the user interface. The item 206 may be a segment of a larger video clip. The computer system 102 can display multiple such video clips in a fifth portion 214 and additionally display a border around a particular video clip so that a user can identify the segment of the particular video clip that the item 206 represents. In some implementations, the computer system 102 can display audio objects (for example, audio object 218a, audio object 218b, audio object 218c, audio object 218d, audio object 218e, audio object 2180 that each represents an audio component of the multiple audio components included in the item 206 in a third portion 216 of the user interface instead of (or in addition to) in the second portion 210, either by default or in response to input.

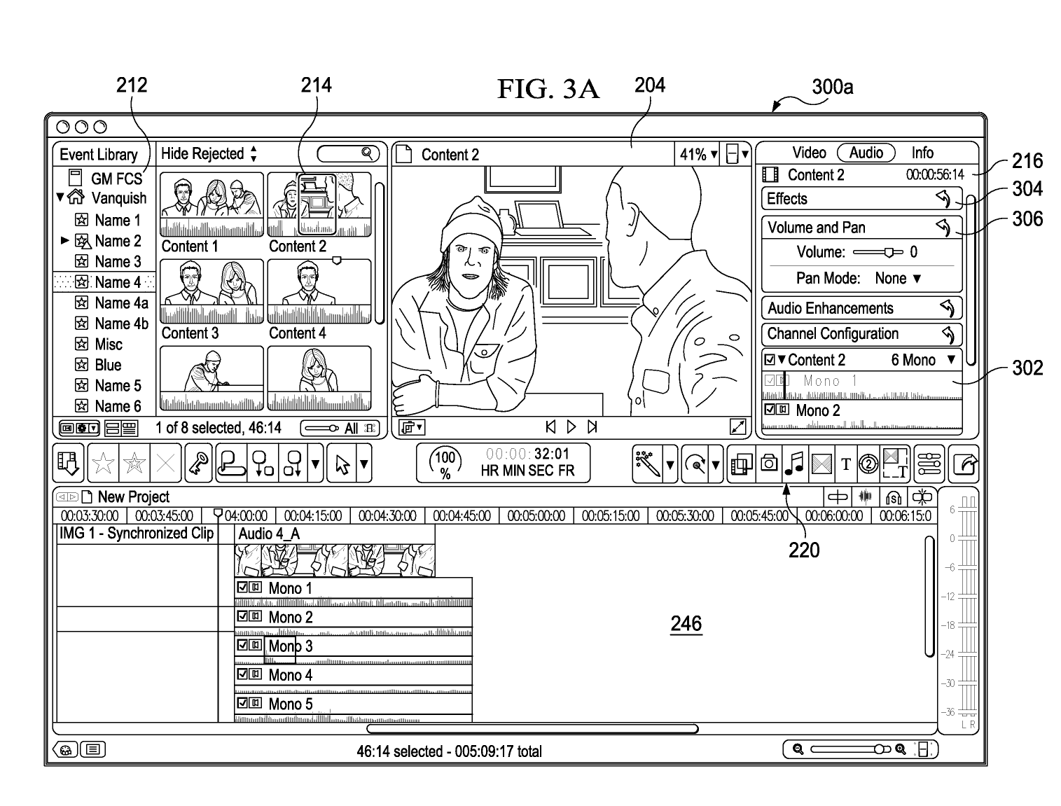

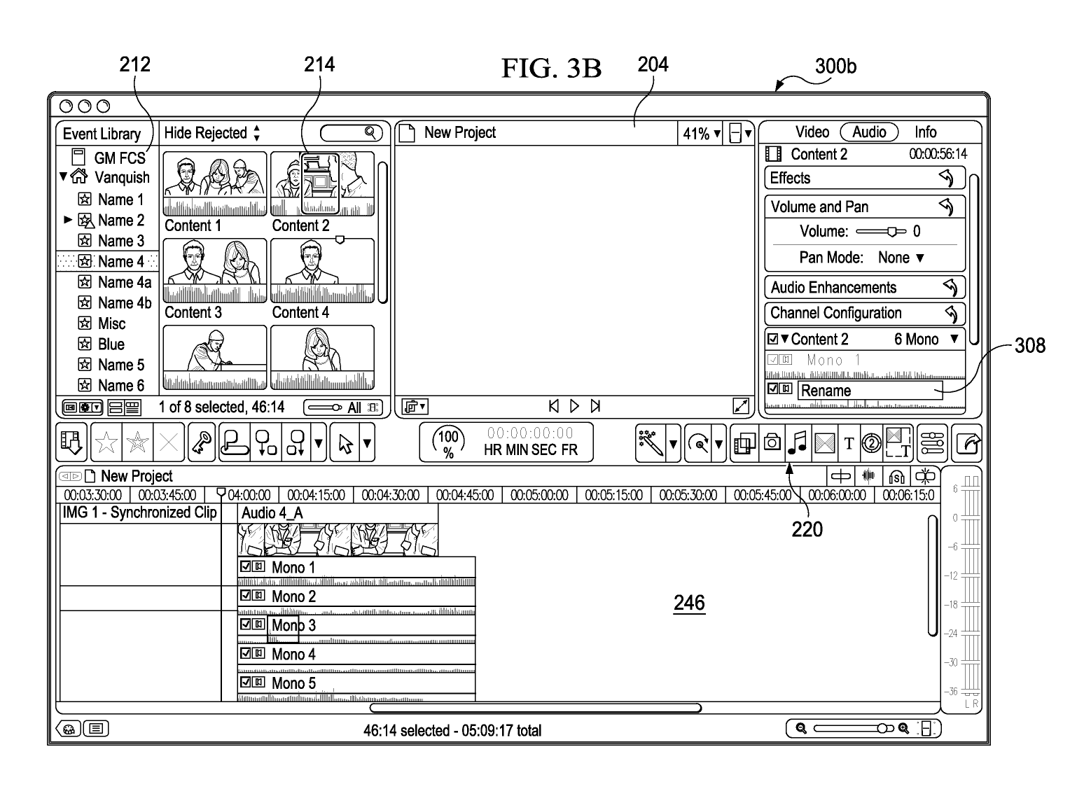

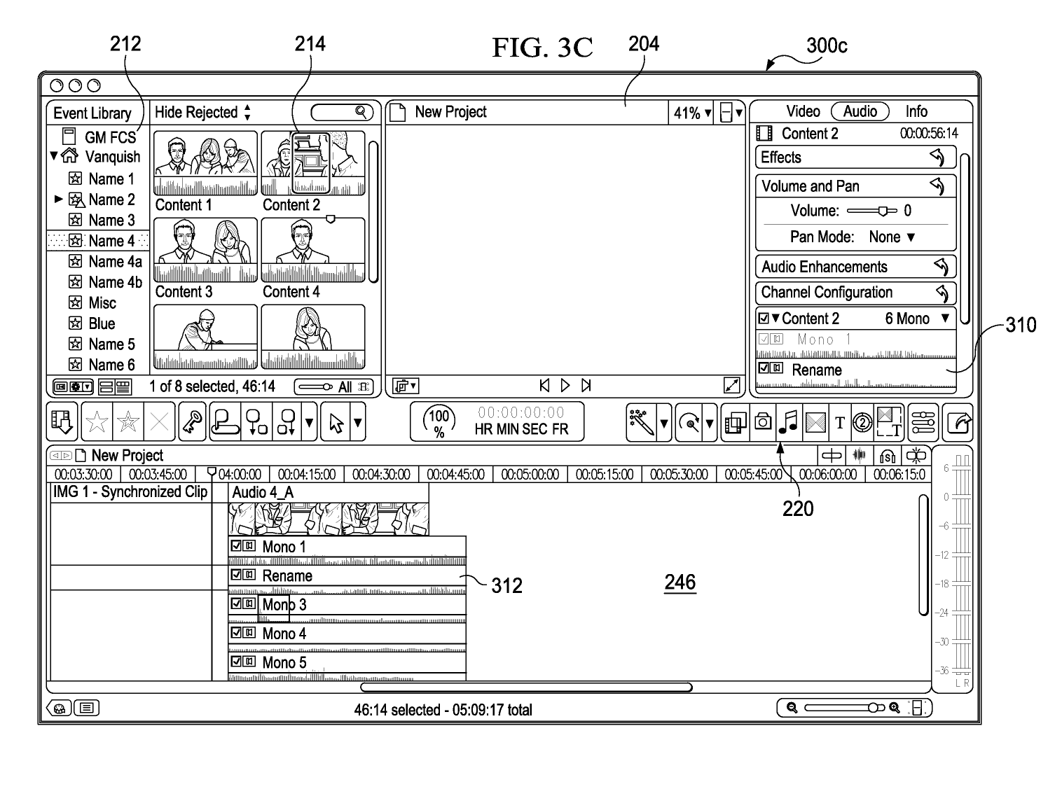

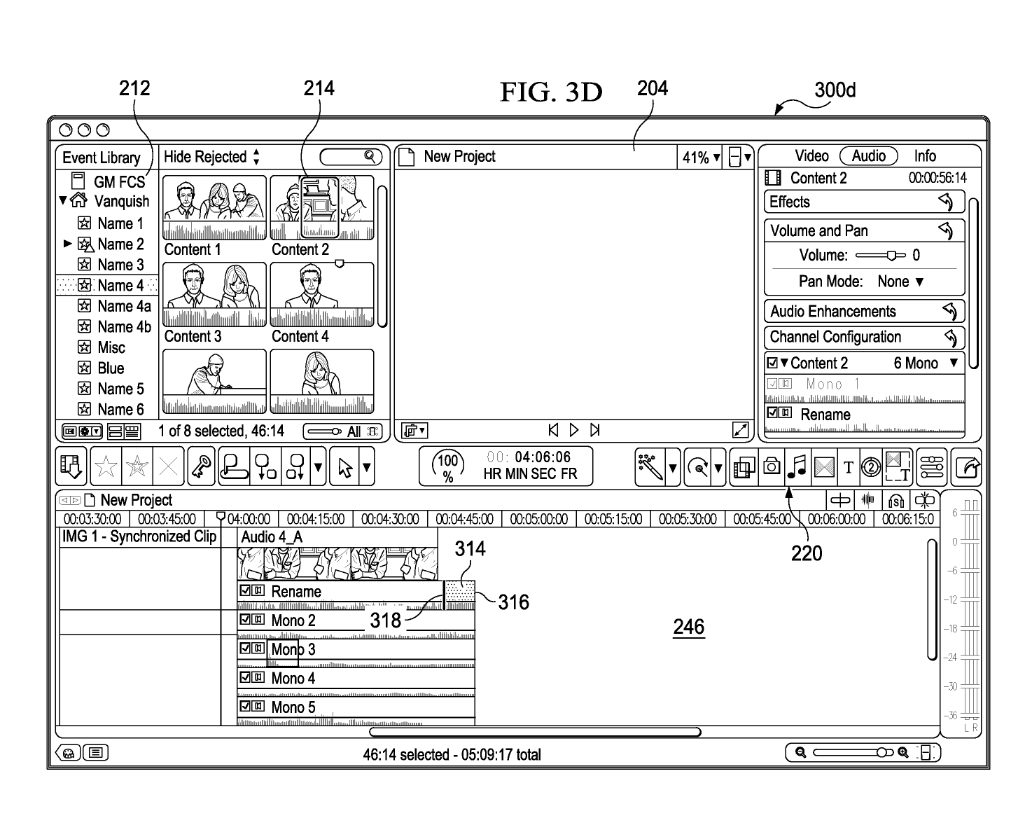

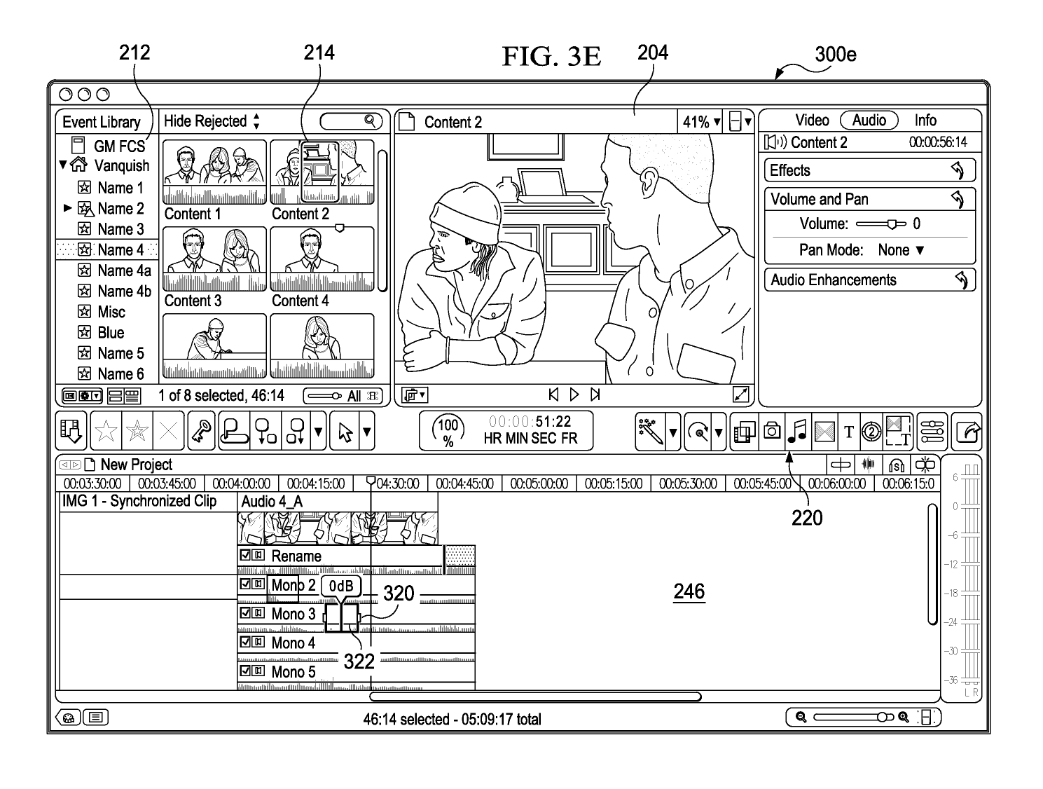

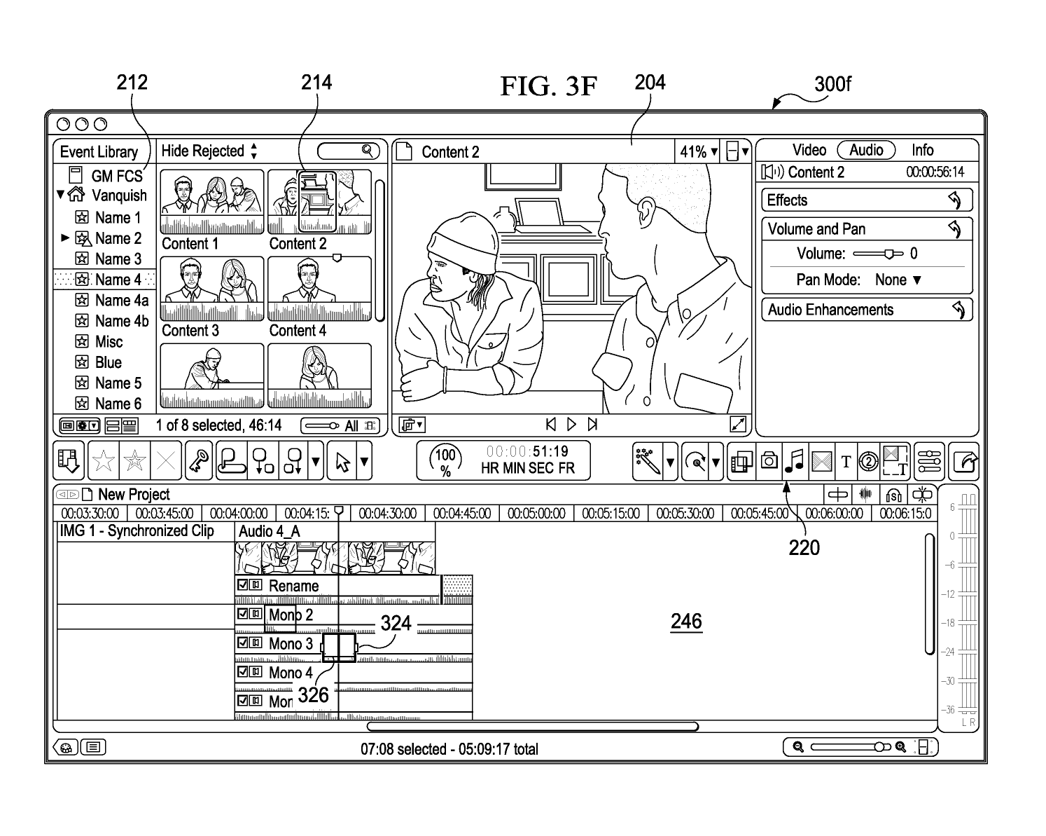

FIGS. 3A-3F are examples of user interfaces that present audio components included in items of digital multimedia content as editable audio objects. As shown in user interface 300a (FIG. 3A), multiple audio objects representing audio components of the audio content included in the item are displayed in two portions. Operations to modify the features of the audio components can be performed in audio objects displayed in both portions. In some implementations, the computer system 102 can detect input selecting the entire video content. For example, the computer system 102 can detect a selection of the entire video object that represents the item of digital multimedia content. In response, the computer system 102 can display controls in the user interface 300a to edit the video content. In some implementations, the computer system 102 can detect that the user has selected an audio object 302 that represents a monophonic audio channel. In response, the computer system 102 can display the control panel 304 that includes controls 306 using which the user can modify features of the audio component represented by the object 302. As described above with reference to FIG. 2E, the computer system 102 can display the audio object representing the audio component (or the audio content), and any modifications made to the item of digital multimedia content as a consequence of modifications to one or more audio components (or the audio content as a whole). The modified item or the audio content alone can be previewed, for example, by skimming, played back, or disabled (i.e., turned off) responsive to user input.

In some implementations, the computer system 102 can assign names to each audio component of the multiple audio components included in the audio content of the item of digital multimedia content. The computer system 102 can display a name of each audio component in the user interface 300b (FIG. 3B). The computer system 102 can enable a user to edit a name of each audio component. For example, the computer system 102 can detect a selection of an audio object 308 that displays the name of the audio component. In response to the selection, the computer system 102 can present a portion of the audio object 308 as an editable control object. In the editable control object, the user can provide a modified name. The computer system 102 can display the modified name of the audio component instead of the previously displayed name in response to the user input.

As described above with reference to FIG. 2E, the computer system 102 can display the audio objects that represent audio components in at least two portions of the user interface. When the computer system 102 receives input to modify a name assigned to the audio component in one portion of the user interface, the computer system can automatically display the modified name in another portion of the user interface. For example, as shown in user interface 300c (FIG. 3C), the user provided input to modify the name assigned to the audio object 310. The audio object 312 represents the same audio component that the audio object 310 represents. The computer system 102 automatically modified the name of the audio object 312 to match the modified name of the audio object 310.

In some implementations, the computer system 102 can create “mute regions” (also known as “knocked out regions”) in response to user input and disable all features of the audio component within the knocked out regions. To create a knocked out region, the user can select a portion of an audio object as described above with reference to FIG. 2F. Alternatively, the user can position a pointing device at an edge 316 (for example, a right edge) of an audio object (FIG. 3D) to select the edge. The user can then move the pointing device inward over the audio object until the user reaches a position 318 within the audio object. The portion 314 of the audio object between the edge 316 and the position 318 represents the knocked out region. Some or all of the features of the audio component within the portion 314 are disabled in response to the creation of the knocked out region.

The user interface 300e (FIG. 3E) shows another example of modifying a feature (for example, a decibel level) of a portion of an audio component. The computer system 102 detects the selection of a portion 320 of the audio object, and responsively displays a border around the portion 320 that allows a user to visually discern the selected portion from the remainder of the audio object. As described above, the computer system 102 displays a horizontal line 322 within the portion 320 at a position that represents a level of the feature. The computer system 102 detects a modification of the position of the horizontal line 322 within the portion 320, and modifies the feature of the audio component only in the selected portion in response to and according to the modification of the position of the horizontal line 322. For example, if the horizontal line 322 is positioned at a top of the portion 320, then the computer system 102 sets the decibel level to a maximum level. Conversely, if the horizontal line 326 is positioned closer to the lower edge of the selected portion 324 (user interface 300f in FIG. 3F), then the computer system 102 decreases a decibel level of the portion of the audio component according to the position of the horizontal line 326. Once modified, the border surrounding the portion 324 can be hidden from display. In this manner, a portion or portions of one or more audio components can be modified by selecting a respective portion or portions of one or more objects that represent the one or more audio components.

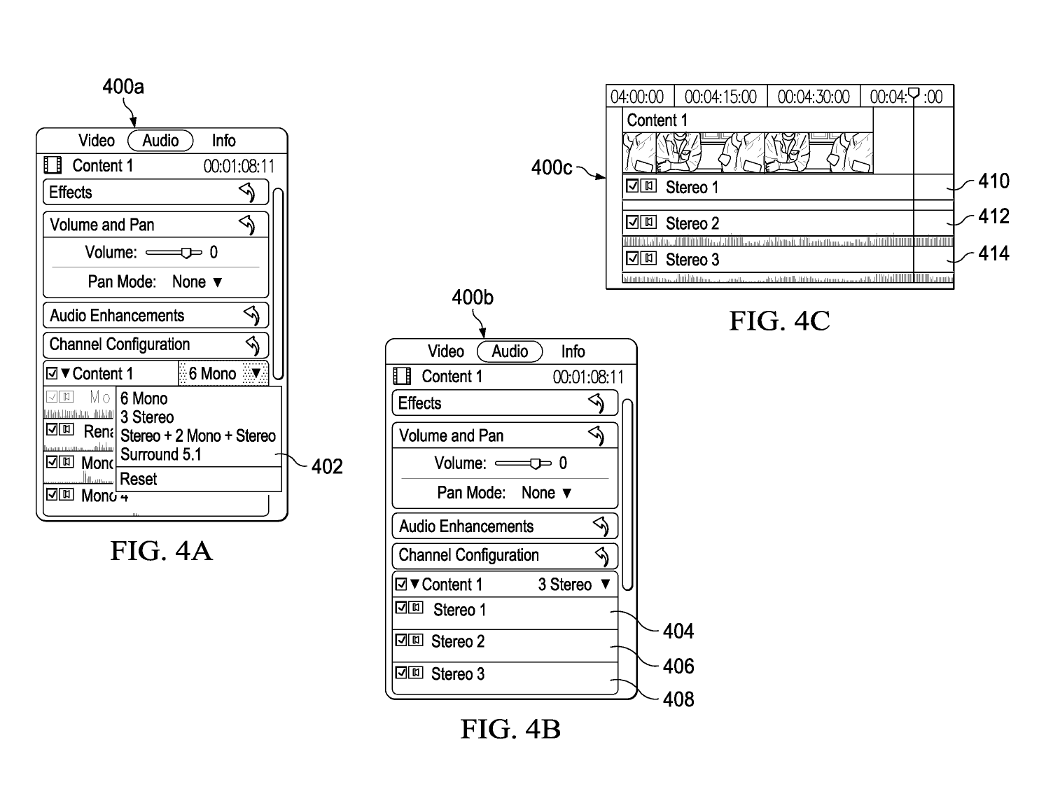

FIGS. 4A-4C are examples of user interfaces for editing audio objects that represent audio components included in items of digital multimedia content. As described above, the audio content can be displayed in the user interfaces as multiple audio components, each representing audio in a respective monophonic audio channel. In some implementations, the computer system 102 can display a first option to organize and display the multiple monophonic audio channels into one or more stereophonic audio components and a second option to organize and display the multiple monophonic audio channels into a single component. For example, in response to input received in a user interface 400a (FIG. 4A), the computer system 102 can display a panel 402 (for example, a heads-up display) that includes manners in which the audio content can be displayed. The panel 402 displays “6 Mono,” “3 Stereo,” “Stereo+2 Mono+Stereo,” and “Surround 5.1” indicating that the audio content can be displayed as six monophonic audio components, three stereophonic audio components, two stereophonic audio components and two monophonic audio components, and one stereo component, or 1 surround component respectively. Stereophonic sound, monophonic sound, and surround sound can describe a relationship among different audio channels or the configuration when audio is recorded. For example, on a camera that records two channels as stereophonic sound, but has two separate inputs, separate microphones can record two separate, unrelated monophonic inputs, which the camera can interpret as being stereophonic sound. Stereophonic sound can also represent related audio signals, for example, recorded by two closely placed microphones that are recording left/right parts of audio. Two monophonic channels can represent audio recorded using two separate microphones on two actors. Because the user interface 400a presently displays the audio channels as six monophonic audio components, the computer system 102 displays a check symbol adjacent to “6 Mono.”

The computer system 102 can detect a selection of either the first option or the second option. For example, the computer system 102 can detect that the user has selected the option “3 Stereo” that represents input to display the six monophonic audio channels as three stereophonic audio components. In response, the computer system 102 can organize and display the multiple audio channels into multiple stereophonic audio components. As shown in user interface 400b (FIG. 4B), the computer system 102 displays three audio objects (objects 404, 406, and 408), each representing a stereophonic audio component. As described above, the multiple objects that represent the audio components can be displayed in multiple portions of the user interface. Thus, when the computer system 102 receives input to collapse the six monophonic audio components into three stereophonic audio components in user interface 400a, the computer system 102 can display three audio objects (objects 410, 412, and 414) in the other portion of the user interface 400b instead of the six objects representing the six monophonic audio components, as shown in FIG. 4C. By providing input through the panel 402, the user can cause the computer system 102 to display six audio objects representing the six monophonic audio components in place of the three audio objects representing the three stereophonic audio components. The user can similarly provide input to display one audio object representing the audio content in place of multiple audio objects representing multiple audio components included in the audio content.

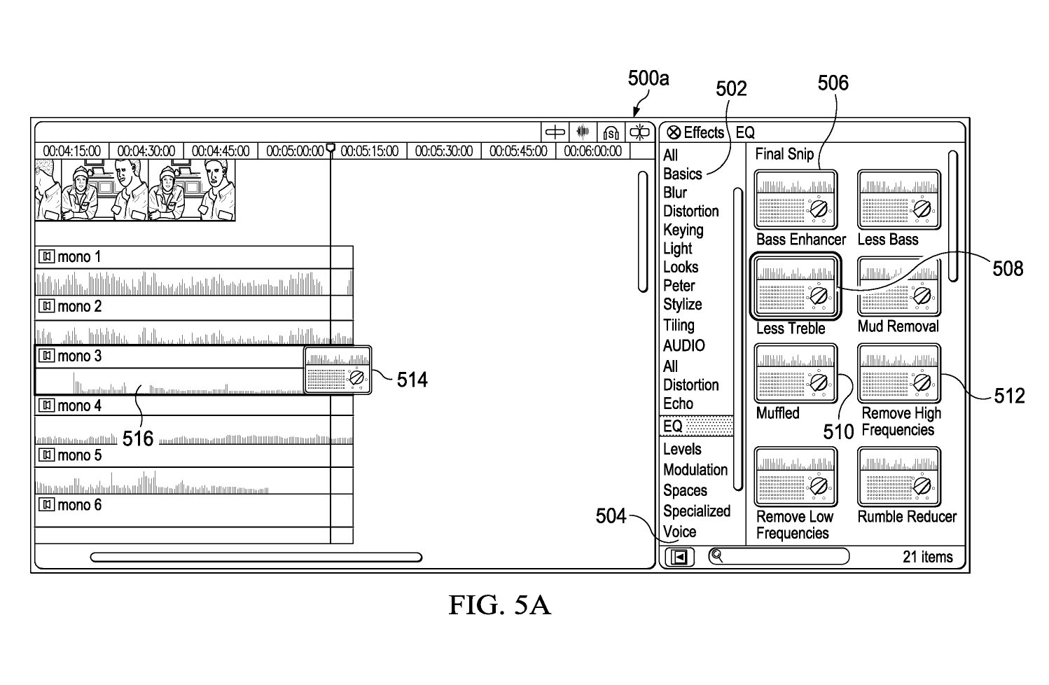

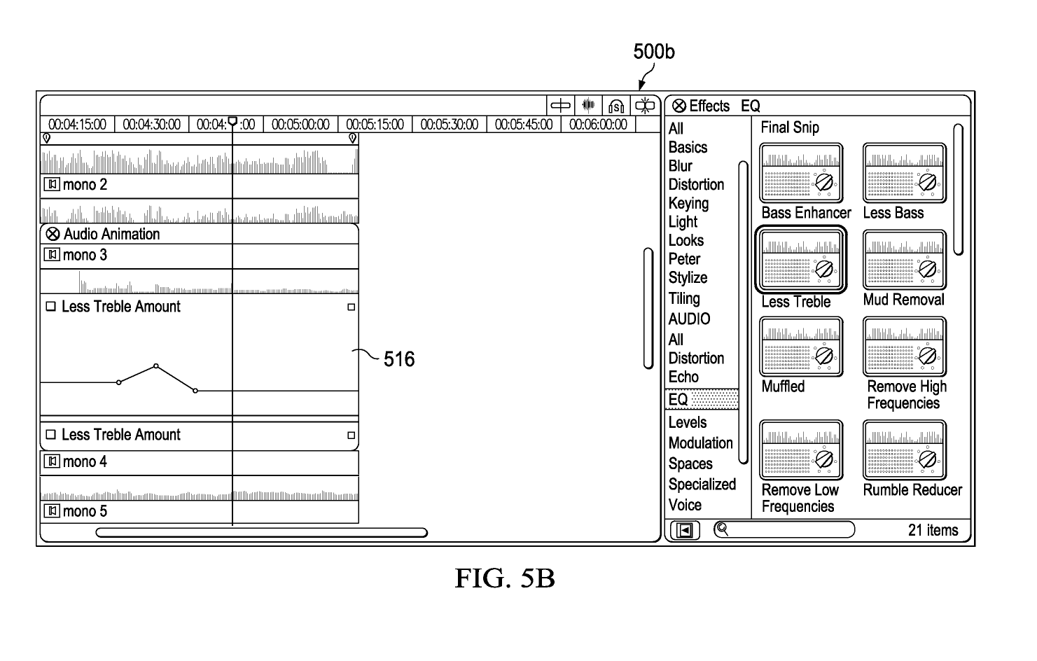

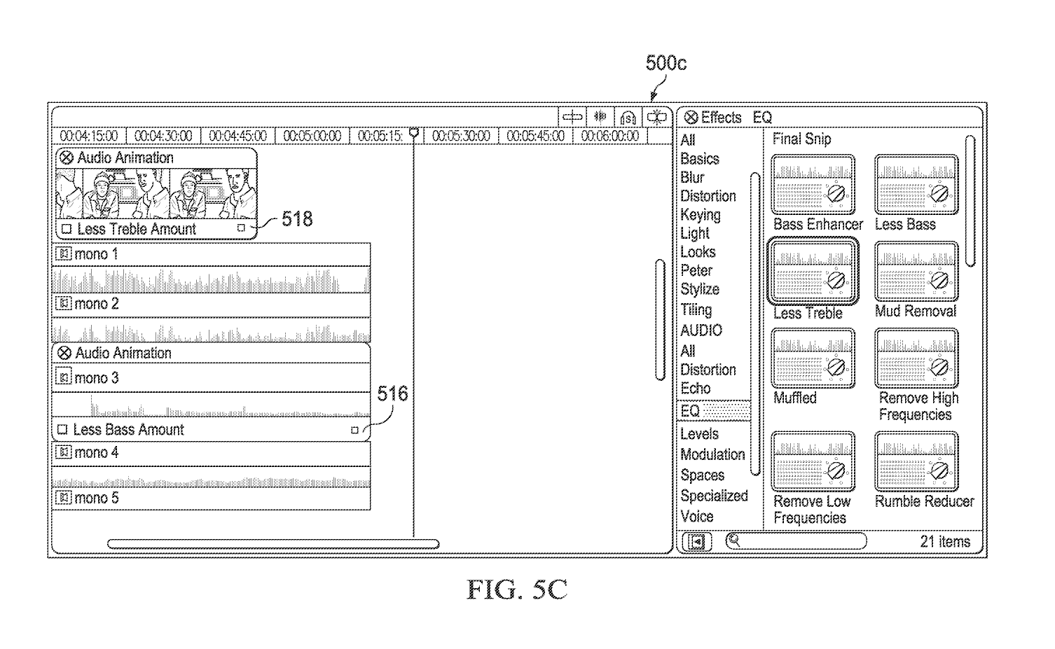

FIGS. 5A-5C are examples of user interfaces for applying effects to audio components. Effects that can be applied to audio components can include bass, treble, frequencies, rumble, muffling, and the like. In some implementations, the computer system 102 can enable a user to apply effects to or adjust effects already applied to audio components by providing each effect as a selectable effects object that a user can apply on an audio component. To do so, the computer system 102 can display a panel 504 over a portion 502 of the user interface 500a (FIG. 5A) and display multiple effects objects (for example, effects objects 506, 508, 510, 512) in the panel 504. Each effects object represents a predefined modification that is applicable to one or more features (for example, attributes or characteristics) in an audio component.

The computer system 102 can detect a selection of a particular effects object 514 that represents a particular predefined modification and a particular audio object 516 displayed in the user interface 500a that represents a particular audio component. For example, the user can perform a drag-and-drop operation by selecting the effects object 514, dragging the effects object 514 across the user interface 500a and dropping the effects object 514 over the audio object 516. In response to this input, the computer system 102 can modify one or more effects in the particular audio component according to the predefined modification. For example, to visually communicate the modification of the audio component represented by the audio object 516 according to the effect represented by the effects object 514, the computer system 102 can display the audio object 516 to be visually discerned from other audio objects representing other audio components. For example, the computer system 102 can display a border around the audio object 516 or display the audio object 516 in a lighter color than other audio objects.

In some implementations, the computer system 102 can enable a user to edit and key frame an effect applied to the audio component. As shown in the user interface 500b (FIG. 5B), in response to receiving input to apply a “Less Treble” effects object to the audio object 516, the computer system 102 displays the audio object 516 as having a larger vertical dimension than other audio objects that represent other audio components. The computer system 102 can receive input from the user within the enlarged audio object 516 to edit and key frame the treble effect applied to the audio component.

The computer system 102 can additionally enable a user to apply multiple effects to the audio content. More specifically, the computer system 102 can receive a first input to apply a first effect (“Less Bass”) to only an audio component (“mono 3”) included in the audio content and a second input to apply a second effect (“Less Treble”) to the entire audio content collectively represented by all the audio components. In response to receiving the first input to apply the first effect to only the audio component, the computer system 102 can modify features of the audio component according to the first effect. In response to receiving the second input to apply the second effect to the entire audio content, the computer system 102 can modify features of the audio content according to the second effect alone. As shown in the user interface 500c (FIG. 5C), the computer system 102 can display a name of the effect applied to the audio component in the object 516 displayed adjacent the audio object representing the audio component (“mono 3”) to which the effect was applied. Similarly, the computer system 102 can display a name of the effect applied to the audio content in the object 518 displayed adjacent the audio object representing the audio component. The computer system 102 can display a name of the effect applied to the audio content to the single audio object 518 that represents the audio content. Alternatively, or in addition, the computer system 102 can display the audio object to which the effect is applied in a manner that is visually discernible from the remaining objects, for example, in a color that is different from colors of the remaining objects.

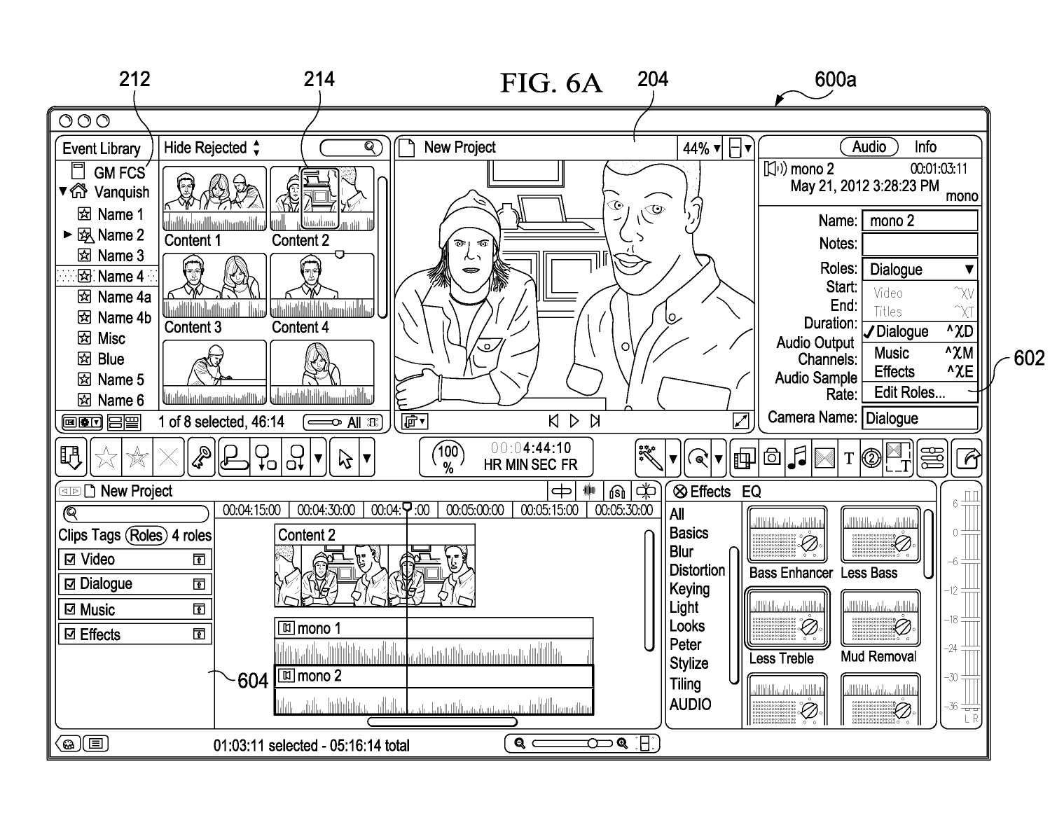

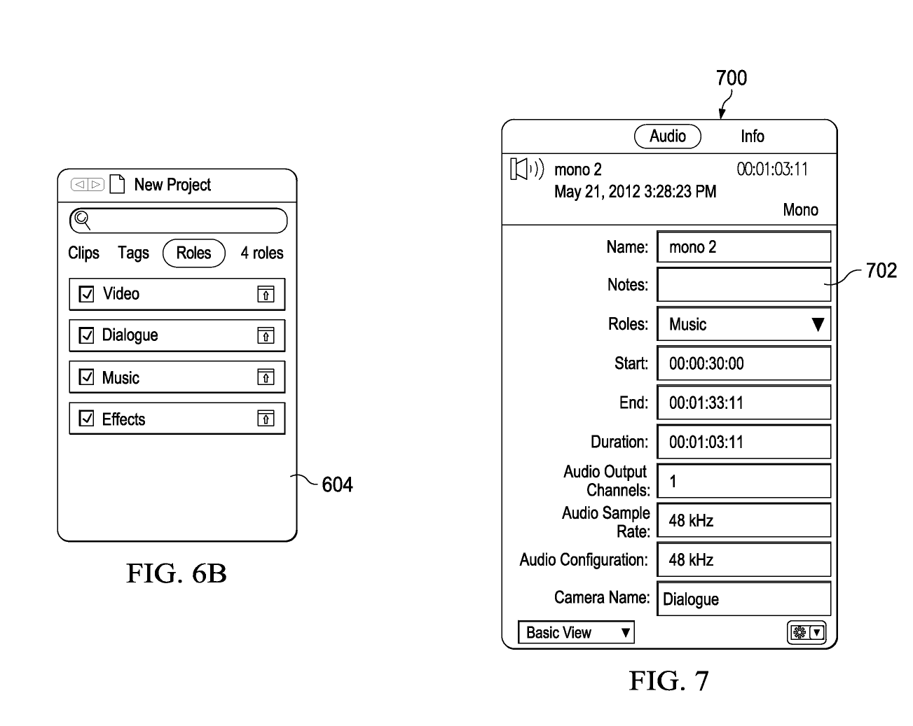

FIGS. 6A and 6B are examples of user interfaces for applying roles to audio components. In some implementations, the computer system 102 can receive input to assign an audio type to an audio component, and assign the audio type to the audio component in response to the input. The audio type can be a role assigned to the audio component. For example, as described above, the item of digital multimedia content can include video showing two persons having a conversation and audio that includes the persons' voices, background music, ambient noises, and the like. Thus, in some examples, the audio type can include a dialogue, a music, effects, a voice-over, ambient noises, and the like. The computer system 102 can enable a user to assign an audio type (i.e., a role) to each audio component included in the audio content.

As shown in user interface 600a (FIG. 6A), the computer system 102 can display a panel 602 that includes multiple roles that can be assigned to audio components. By default, the computer system 102 can provide some roles, for example, “Dialogue,” “Music,” “Effect,” and the like. The computer system 102 can additionally provide a control that can be selected to add additional roles. For example, the user can select the control and enter “Ambient Noise” in response to which the computer system 102 can add an “Ambient Noise” role to the panel 602. The user can assign roles to audio components using the panel 602.

Using controls in the panel 604, audio components that are assigned a certain role (or roles) can be controlled, for example, turned off. For example, in the panel 604, the control “Music” has been disabled (i.e., de-selected) whereas the controls “Video,” “Dialogue,” and “Effects,” are enabled (i.e., selected). The computer system 102 can turn off the audio component or components that have been assigned “Music” as the role while enabling remaining audio component or components.

FIG. 7 is an example of a user interface for modifying the metadata of audio components. As shown in user interface 700, the computer system 102 can display a panel 702 in response to input, which includes metadata associated with an audio component. The metadata can include, for example, a start time, an end time, and a duration of the audio component, information describing whether the component is monophonic or stereophonic, an output channel, a sample rate, audio configuration, a name of a device using which the audio component was captured, the audio type (i.e., the role) assigned to the audio component, and the like. The computer system 102 can be configured to automatically identify some of the metadata assigned to the audio component. For example, the computer system 102 can receive the metadata from the source of the audio component. The computer system 102 can receive input, for example, from a user to provide metadata that the computer system 102 cannot automatically identify or to modify the metadata or both. For example, the computer system 102 can receive from the user, a name of the audio component, notes describing the audio component, and the like. Similarly, the computer system 102 can receive changes to roles assigned to the audio components. To cause the computer system 102 to display the panel 702, the user can select an audio object that corresponds to the audio component for which the user wants to view metadata.

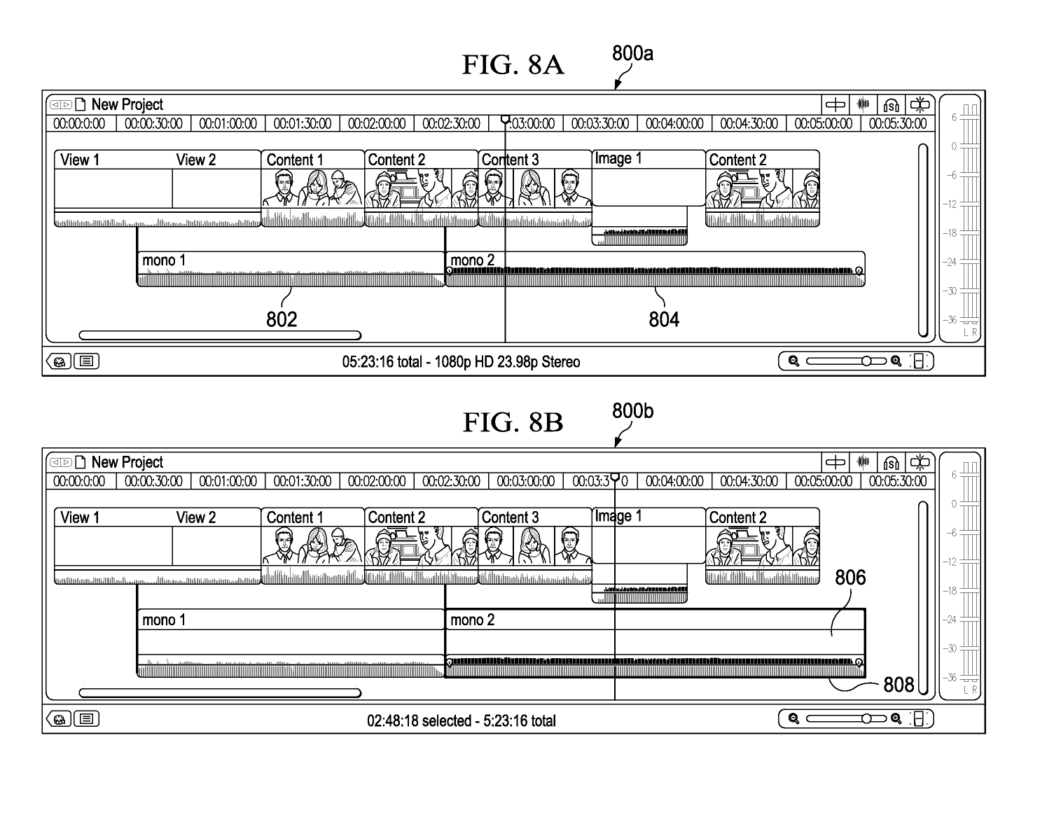

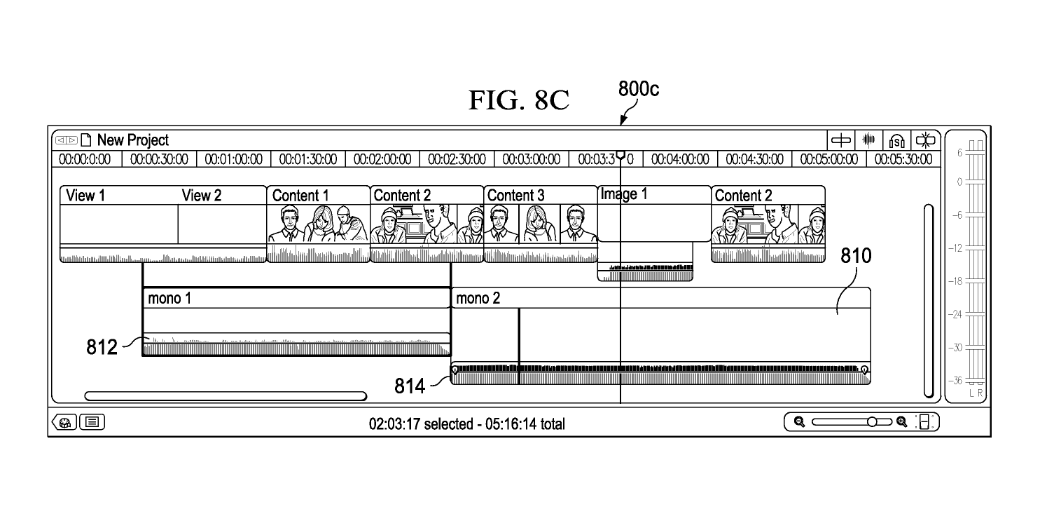

FIGS. 8A-8C are examples of user interfaces for editing audio content included in items of digital multimedia content. As shown in user interface 800a (FIG. 8A), the computer system 102 can display the audio content alone in the user interface 800a as separate audio objects (for example, audio object 802, audio object 804). As shown in user interface 800b (FIG. 8B), the computer system 102 can display the split edits of the audio content to see the audio as separate audio objects (for example, audio object 806, audio object 808) to see the audio separately once the audio is in a B-roll spine. As shown in user interface 800c (FIG. 8C), an audio object representing an audio component (or the audio content of an item of digital multimedia content) can be extended to overlap over another audio object representing another audio component (or the audio content of another item of digital multimedia content). For example, FIG. 8C shows the audio represented by the audio object 810 overlapping the audio represented by the audio object 812 to create fade-in/fade-out portions. When an item of digital multimedia content that includes the audio represented by the audio object 812 is played back, then a portion of the audio represented by the overlapping region 814 plays back before the item of digital multimedia content ends. The computer system 102 can enable a user to create such fade-ins/fade-outs on both ends of each audio component or on both ends of the entire audio content or both.

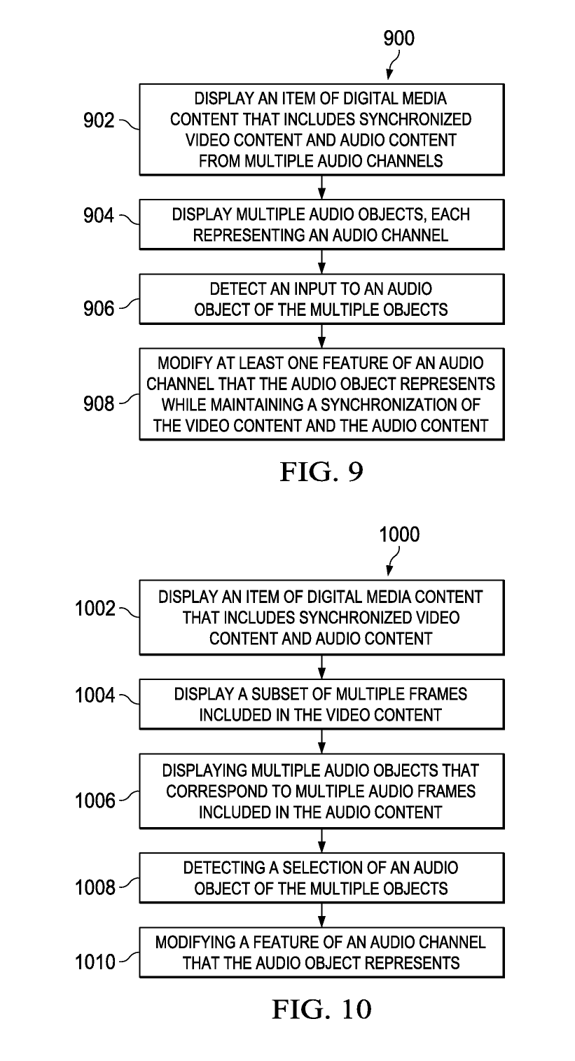

FIG. 9 is a flowchart of an example process 900 for modifying a feature of an audio component included in an item of digital multimedia content. The process 900 can be implemented as computer instructions stored on a computer-readable medium and executable by data processing apparatus. For example, the process 900 can be implemented by the computer system 102. At 902, the computer system 102 can display, in a first portion of a user interface, an item of digital multimedia content that includes video content and audio content that is synchronized with the video content. The audio content includes audio from multiple audio components. At 904, the computer system 102 can display, in a second portion of the user interface, multiple audio objects, each representing an audio component of the multiple audio components. At 906, the computer system 102 can detect an input to an audio object of the multiple audio objects. At 908, the computer system 102 can modify at least one feature of an audio component that the audio object represents while maintaining a synchronization of the video content and the audio content. For example, if the computer system 102 modifies a feature of a stereophonic audio component in response to input, the computer system 102 can modify all of the audio content according to the modified feature of the stereophonic audio component.

FIG. 10 is a flowchart of an example process 1000 for modifying a feature of an audio component included in an item of digital multimedia content. The process 1000 can be implemented as computer instructions stored on a computer-readable medium and executable by data processing apparatus. For example, the process 1000 can be implemented by the computer system 102. At 1002, the computer system 102 can display an item of digital multimedia content that includes synchronized video content and audio content in a user interface. The video content can include multiple frames and the audio content can include audio from multiple audio components. At 1004, the computer system 102 can display, in the user interface, a subset of the multiple frames included in the video content. At 1006, the computer system 102 can display, in the user interface, multiple audio objects that correspond to the multiple audio components. The multiple audio objects can represent a portion of audio content included in the multiple audio components and synchronized with the subset of the multiple frames. At 1008, the computer system can detect a selection of an audio object of the multiple objects. At 1010, the computer system 102 can modify a feature of an audio component that the audio object represents in response to detecting the selection of the audio object. For example, the computer system 102 can display a modification to the feature as an animation within the audio object.

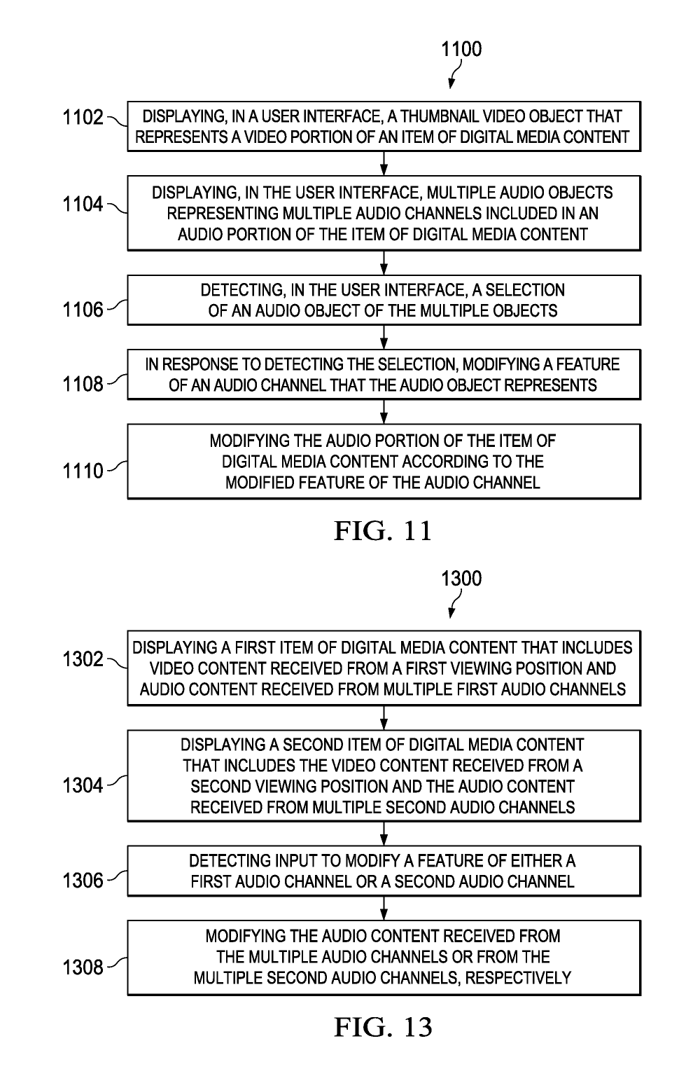

FIG. 11 is a flowchart of an example process 1100 for modifying a feature of an audio component included in an item of digital multimedia content. The process 1100 can be implemented as computer instructions stored on a computer-readable medium and executable by data processing apparatus. For example, the process 1100 can be implemented by the computer system 102. At 1102, the computer system 102 can display, in a user interface, a thumbnail object that represents a video portion of an item of digital multimedia content. At 1104, the computer system 102 can display, in the user interface, multiple audio objects representing multiple audio components included in an audio portion of the item of digital multimedia content. At 1106, the computer system 102 can detect, in the user interface, a selection of an audio object of the multiple audio objects. In response to detecting the selection, the computer system 102 can modify a feature of an audio component that the audio object represents at 1108. At 1110, the computer system 102 can modify the audio portion of the item of digital multimedia content according to the modified feature of the audio component.

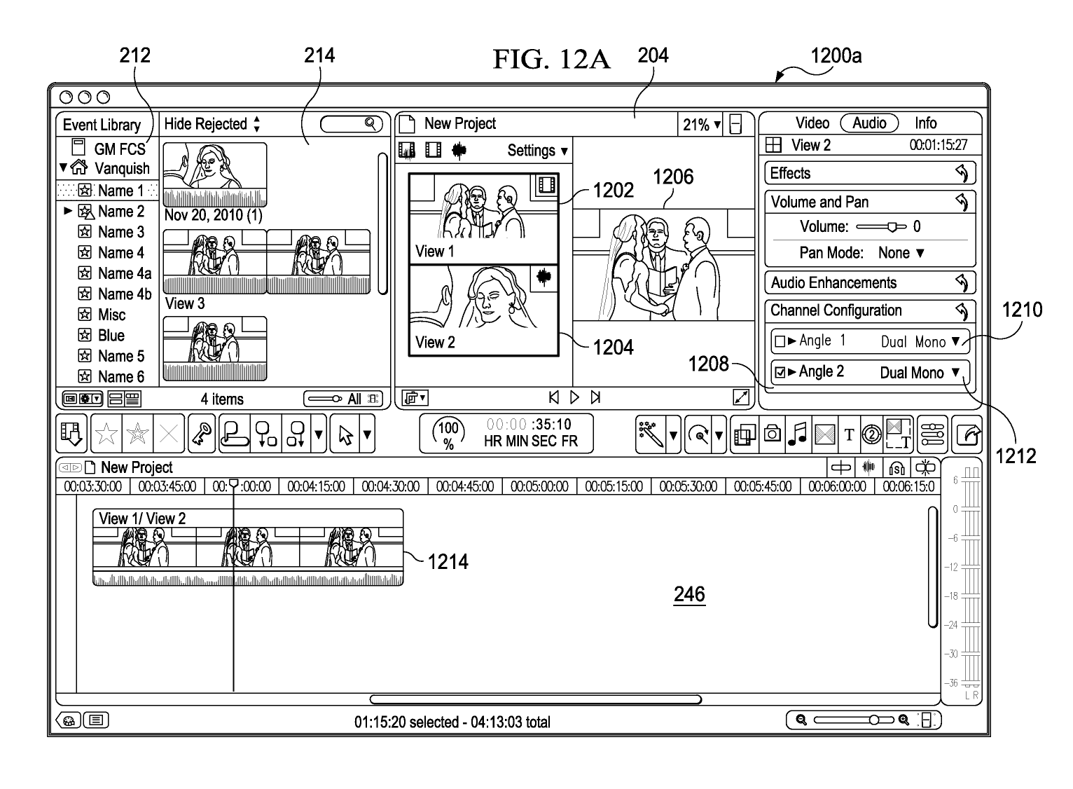

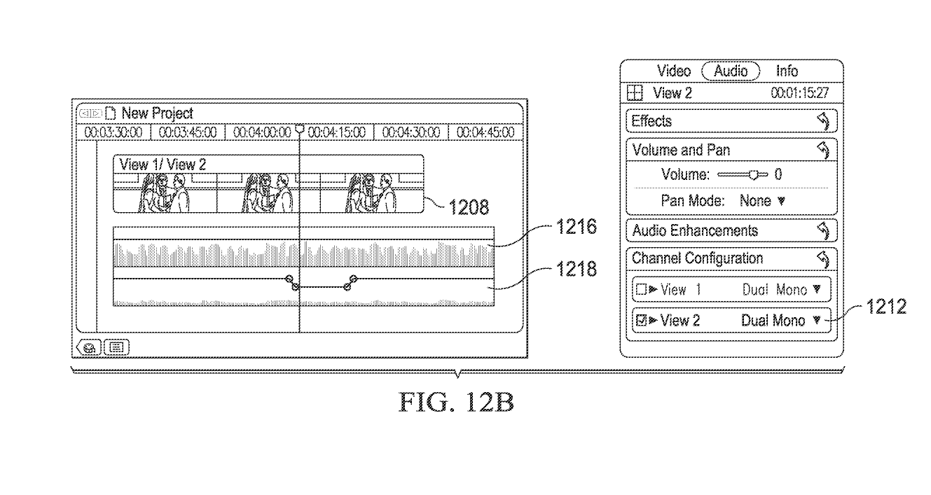

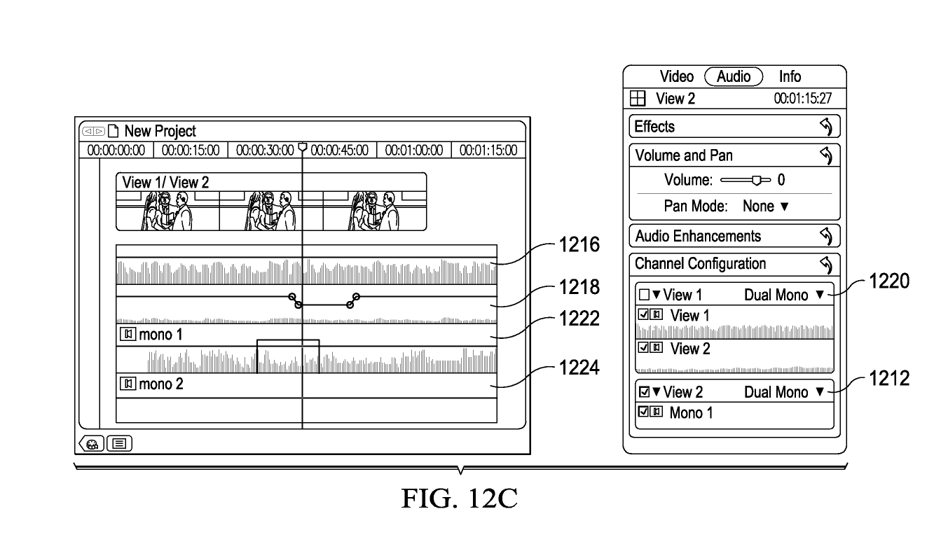

FIGS. 12A-12C are examples of user interfaces for editing audio content included in items of digital multimedia content captured from two viewing positions. In some implementations, the computer system 102 can display, in a user interface 1200a (FIG. 12A), a first item of digital multimedia content 1202 that includes video content received from a first viewing position and audio content received from multiple first audio components. The audio content can be synchronized with the video content. For example, the first item of digital multimedia content can be content captured from a first angle with a first camera and a first set of microphones. The computer system 102 can display, in the user interface 1200a, a second item of digital multimedia content 1204 that includes the video content received from a second viewing position and the audio content received from multiple second audio components. For example, the second item of digital multimedia content can be the same content as the first item 1202 but captured from a second angle with a second camera and a second set of microphones. The computer system 102 can enable a user to modify a feature of audio content of either the first item 1202 (i.e., one or more first audio components) or the second item 1204 (i.e., one or more second audio components), or both, while maintaining a synchronization between the video content and the audio content.

For example, the computer system 102 can detect a selection of first item 1202. The selection represents input to edit audio content included in the first item 1202, i.e., content captured from the first angle. The computer system 102 can additionally display a first audio object 1210 that represents the audio content received from the first viewing position and a second audio object 1212 that represents the audio content received from the second viewing position in a portion 1208 of the user interface. The computer system 102 can additionally display the video content received from the selected viewing position and the audio content received from the selected viewing position in respective video objects and audio objects in the portion 1214 of the user interface 1200a. Thus, the computer system 102 can enable a user to modify audio content from any viewing position (for example, the first viewing position) while viewing video content from the same viewing position (i.e., the first viewing position) or from the other viewing position (i.e., the third viewing position). The computer system 102 can similarly enable the user to modify features of audio components captured from more than two viewing positions, i.e., more than two angles.

As described above, the computer system 102 can display the entire audio content received from the first viewing position and the second position as a single audio object. The computer system 102 can enable a user to modify features of the audio content by providing input to the single audio object. In some implementations, the computer system 102 can detect a selection of the first object 1210 or the second object 1212. In response, the computer system 102 can display audio objects that represent the first audio components or audio objects that represent the second audio components, respectively. The computer system 102 can enable the user to modify features of each audio component by providing input to a respective audio object that represents the audio component. The computer system 102 can display only one set of audio components at a time resulting in the first audio components being hidden from display when the second audio components are selected for display. Alternatively, the computer system 102 can display both audio components simultaneously in the user interface.

As shown in FIG. 12B, when the computer system 102 detects a selection of the object 1212, the computer system 102 can display two audio objects (audio object 1216, audio object 1218), each representing a monophonic audio component included in the audio content received from the second viewing position below the video content 1208. Using techniques described above, a user can edit each monophonic audio component by providing input to a respective audio object. As shown in FIG. 12C, the computer system 102 can detect a selection of audio object 1212 that represents the audio content received from the second viewing position and the audio object 1220 which represents the audio content received from the first viewing position. In response, the computer system 102 can display audio objects representing the monophonic audio components adjacent to the audio objects 1212 and 1220, and also adjacent to the video content as audio objects 1216, 1218, 1222, and 1224.

In some implementations, the video content can include multiple frames. The computer system 102 can detect a selection of a portion of the first item of digital multimedia content 1202. In response, the computer system 102 can display a subset of the multiple frames that corresponds to the portion of the first item 1202. The computer system 102 can additionally display multiple audio objects, each of which represents a portion of a first audio component that is synchronized with the portion of the first item 1202.

FIG. 13 is a flowchart of an example process 1300 for modifying a feature of an audio component included in an item of digital multimedia content captured from two viewing positions. The process 1300 can be implemented as computer instructions stored on a computer-readable medium and executable by data processing apparatus. For example, the process 1300 can be implemented by the computer system 102. At 1302, the computer system 102 can display, in a user interface, a first item of digital multimedia content that includes video content received from a first viewing position and audio content received from multiple first audio components. The audio content is synchronized with the video content. At 1304, the computer system 102 can display, in the user interface, a second item of digital multimedia content that includes the video content received from a second viewing position and the audio content received from multiple second audio components. At 1306, the computer system 102 can detect input to modify a feature of either a first audio component or a second audio component. At 1308, the computer system 102 can modify the audio content received from the multiple first audio components or from the multiple second audio components, respectively, in response to detecting the input at 1306.

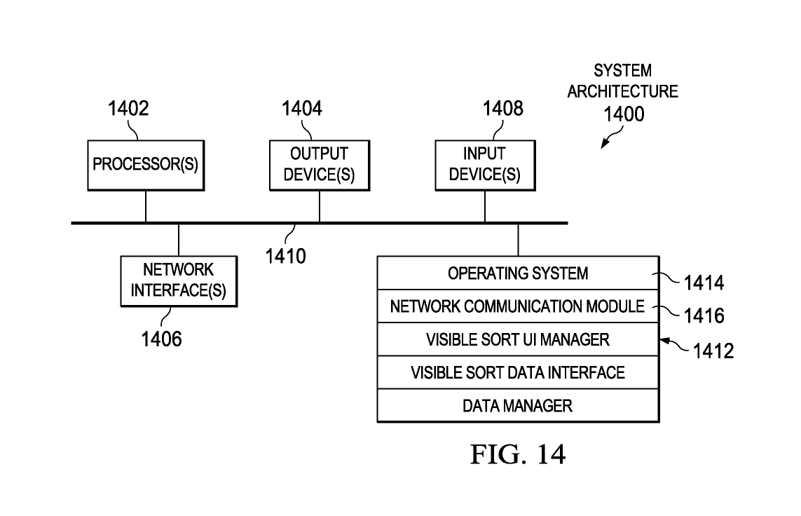

FIG. 14 is a block diagram of an exemplary architecture for implementing the features and operations of FIGS. 1-13. Other architectures are possible, including architectures with more or fewer components. In some implementations, architecture 1400 includes one or more processors 1402 (e.g., dual-core Intel® Xeon® Processors), one or more output devices 1404 (e.g., LCD), one or more network interfaces 1406, one or more input devices 1408 (e.g., mouse, keyboard, touch-sensitive display) and one or more computer-readable mediums 1412 (e.g., RAM, ROM, SDRAM, hard disk, optical disk, flash memory, etc.). These components can exchange communications and data over one or more communication channels 1410 (e.g., buses), which can utilize various hardware and software for facilitating the transfer of data and control signals between components.

The term “computer-readable medium” refers to a medium that participates in providing instructions to processor 1402 for execution, including without limitation, non-volatile media (e.g., optical or magnetic disks), volatile media (e.g., memory) and transmission media. Transmission media includes, without limitation, coaxial cables, copper wire and fiber optics.

Computer-readable medium 1412 can further include operating system 1414 (e.g., a Linux® operating system) and network communication module 1416. Operating system 1414 can be multi-user, multiprocessing, multitasking, multithreading, real time, etc. Operating system 1414 performs basic tasks, including but not limited to: recognizing input from and providing output to devices 1406, 1408; keeping channel and managing files and directories on computer-readable mediums 1412 (e.g., memory or a storage device); controlling peripheral devices; and managing traffic on the one or more communication channels 1410. Network communications module 1416 includes various components for establishing and maintaining network connections (e.g., software for implementing communication protocols, such as TCP/IP, HTTP, etc.).

Architecture 1400 can be implemented in a parallel processing or peer-to-peer infrastructure or on a single device with one or more processors. Software can include multiple software components or can be a single body of code.

The described features can be implemented advantageously in one or more computer programs that are executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program can be written in any form of programming language (e.g., Objective-C, Java), including compiled or interpreted languages, and it can be deployed in any form, including as a stand-alone program or as a module, component, subroutine, a browser-based web application, or other unit suitable for use in a computing environment.

Suitable processors for the execution of a program of instructions include, by way of example, both general and special purpose microprocessors, and the sole processor or one of multiple processors or cores, of any kind of computer. Generally, a processor will receive instructions and data from a read-only memory or a random access memory or both. The essential elements of a computer are a processor for executing instructions and one or more memories for storing instructions and data. Generally, a computer will also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory can be supplemented by, or incorporated in, ASICs (application-specific integrated circuits).

The features can be implemented in a computer system that includes a back-end component, such as a data server, or that includes a middleware component, such as an application server or an Internet server, or that includes a front-end component, such as a client computer having a graphical user interface or an Internet browser, or any combination of them. The components of the system can be connected by any form or medium of digital data communication such as a communication network. Examples of communication networks include, e.g., a LAN, a WAN, and the computers and networks forming the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data (e.g., an HTML page) to a client device (e.g., for purposes of displaying data to and receiving user input from a user interacting with the client device). Data generated at the client device (e.g., a result of the user interaction) can be received from the client device at the server.

A system of one or more computers can be configured to perform particular actions by virtue of having software, firmware, hardware, or a combination of them installed on the system that in operation causes or cause the system to perform the actions. One or more computer programs can be configured to perform particular actions by virtue of including instructions that, when executed by data processing apparatus, cause the apparatus to perform the actions.

While this specification contains many specific implementation details, these should not be construed as limitations on the scope of any inventions or of what may be claimed, but rather as descriptions of features specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

A number of implementations of the invention have been described. Nevertheless, it will be understood that various modifications can be made without departing from the spirit and scope of the invention.

1. A computer-implemented method comprising:
displaying, in a first portion of a user interface, an item of digital multimedia content that includes video content and audio content that is synchronized with the video content, wherein the audio content includes audio from a plurality of audio components;
displaying, in a second portion of the user interface, a plurality of audio objects, each representing an audio component of the plurality of audio components;
detecting an input to an audio object of the plurality of audio objects; and
in response to detecting the input of the audio object, modifying at least one feature of an audio component that the audio object represents while maintaining a synchronization of the video content and the audio content.

2. The method of claim 1, further comprising displaying the item of digital multimedia content in the second portion of the user interface and adjacent to the plurality of audio objects.

3. The method of claim 2, wherein the item of digital multimedia content spans a duration, the method further comprising:
displaying the item of digital multimedia content as a video object of a dimension that corresponds to the duration of the item of digital multimedia content; and
displaying an object of the plurality of audio objects with the dimension that corresponds to the duration of the item of digital multimedia content.

4. The method of claim 3, further comprising:
detecting input to extend the dimension of the audio object of the plurality of audio objects beyond the dimension; and
in response to detecting the input, extending an audio component that the audio object represents beyond the duration of the item of digital multimedia content.

5. The method of claim 1, wherein each audio component is a monophonic audio channel.

6. The method of claim 5, further comprising organizing the plurality of monophonic audio channels into one or more stereophonic audio components in response to input, wherein each audio component of stereophonic sound includes two monophonic audio channels.

7. The method of claim 6, further comprising:
modifying a feature of a stereophonic audio component in response to input, and
modifying the audio content according to the modified feature of the stereophonic audio component.

8. The method of claim 1, further comprising displaying another plurality of audio objects, each representing the audio component of the plurality of audio components, in a third portion of the user interface in response to input.

9. The method of claim 1, further comprising:
organizing the plurality of audio objects into a single object representing the audio content in response to input; and
displaying the single audio object in the second portion of the user interface instead of the plurality of audio objects.

10. The method of claim 1, wherein in response to detecting the input of the audio object, modifying at least one feature of an audio component that the audio object represents comprises:
detecting a selection of a portion of the audio object, wherein the portion spans a duration of time; and
in response to detecting the selection of the portion, modifying at least one feature of the audio component that the portion of the object represents.

11. The method of claim 10, wherein the input comprises input to silence audio in the selected portion.

12. A non-transitory computer-readable medium storing instructions executable by data processing apparatus to perform operations comprising:
displaying an item of digital multimedia content that includes synchronized video content and audio content in a user interface, wherein the video content includes a plurality of frames and the audio content includes audio from a plurality of audio components;
displaying, in the user interface, a subset of the plurality of frames included in the video content;
displaying, in the user interface, a plurality of audio objects that correspond to the plurality of audio components, wherein the plurality of audio objects represent a portion of audio content included in the plurality of audio components and synchronized with the subset of the plurality of frames;
detecting a selection of an audio object of the plurality of audio objects; and
in response to detecting the selection of the audio object, modifying a feature of an audio component that the audio object represents.

13. The medium of claim 12, wherein the feature includes a decibel level of the audio component, and wherein modifying the feature of the audio component comprises decreasing the decibel level of the audio component.

14. The medium of claim 12, wherein the operations further comprise:
displaying a name of the audio component that the audio object represents in the second portion of the user interface; and
displaying a modified name of the audio component instead of the name in response to input to modify the name of the audio component.

15. The medium of claim 12, wherein detecting the selection of the audio object of the plurality of audio objects comprises detecting a selection of a portion of the audio object of the plurality of audio objects, and modifying the feature of the audio component in the portion of the audio object comprises disabling all features of a portion of the audio component represented by the portion of the audio object.

16. The medium of claim 15, wherein the operations further comprise:
detecting a selection of a portion of the audio object of the plurality of audio objects;
displaying a border around the portion of the audio object;
displaying a horizontal line within the portion at a position that represents a level of the feature; and
modifying the feature of the audio component in the portion in response to and according to a modification of the position of the horizontal line.

17. The medium of claim 12, wherein each audio component is a monophonic audio channel, and wherein the operations further comprise:
displaying a first option to organize the plurality of monophonic audio channels into one or more stereophonic audio components and a second option to organize the plurality of monophonic audio channels into a single component;
detecting a selection of either the first option or the second option; and
organizing the plurality of monophonic audio channels into either one or more stereophonic audio components or the single component based on the selection.

18. The medium of claim 12, wherein displaying the plurality of audio objects in the user interface comprises displaying the plurality of audio objects below the subset of the plurality of frames, wherein a horizontal dimension of each audio object of the plurality of audio objects is substantially equal to a horizontal dimension of a video object in which the subset of the plurality of frames is displayed.

19. The medium of claim 12, wherein the operations further comprise:
displaying a plurality of effects objects in the user interface, each effects object representing a predefined modification that is applicable to one or more effects in an audio component;
detecting a selection of a particular effects object that represents a particular predefined modification and a particular audio object that represents a particular audio component;
modifying one or more features in the particular audio component according to the predefined modification.

20. The medium of claim 12, wherein modifying a feature of an audio component that the audio object represents comprises displaying a modification to the feature as an animation within the audio object.

21. The medium of claim 12, wherein the operations further comprise:
receiving input to assign an audio type to an audio component; and
assigning the audio type to the audio component in response to the input.

22. The medium of claim 21, wherein the audio type includes at least one of a dialogue, music, or an effect.

23. A system comprising:
one or more data processing apparatus;
a computer-readable medium storing instructions executable by the one or more data processing apparatus to perform operations comprising:
displaying, in a user interface, a thumbnail video object that represents a video portion of an item of digital multimedia content;
displaying, in the user interface, a plurality of audio objects representing a plurality of audio components included in an audio portion of the item of digital multimedia content;
detecting, in the user interface, a selection of an audio object of the plurality of audio objects;
in response to detecting the selection, modifying a feature of an audio component that the audio object represents; and
modifying the audio portion of the item of digital multimedia content according to the modified feature of the audio component.

24. The system of claim 23, wherein the operations further comprise assigning an audio type to each audio component in response to receiving input, and wherein modifying the feature of the audio component that the object represents comprises:
displaying a plurality of audio types in the user interface;
displaying a plurality of selectable controls in the user interface, each selectable control displayed adjacent a respective audio type;
detecting a selection of a particular selectable control displayed adjacent a particular audio type; and
disabling a feature associated with the particular audio type in response to detecting the selection.

25. A computer-implemented method comprising:
displaying, in a user interface, a first item of digital multimedia content that includes video content received from a first viewing position and audio content received from a plurality of first audio components, wherein the audio content is synchronized with the video content;
displaying, in the user interface, a second item of digital multimedia content that includes the video content received from a second viewing position and the audio content received from a plurality of second audio components; and
in response to detecting input to modify a feature of either a first audio component or a second audio component, modifying the audio content received from the plurality of first audio components or from the plurality of second audio components, respectively.

26. The method of claim 25, further comprising:
detecting a selection of the first item of digital multimedia content; and
in response to detecting the first item of digital multimedia content:
displaying the plurality of first audio components, and
hiding from display the plurality of second audio components.

27. The method of claim 25, wherein the video content includes a plurality of frames, and wherein the method further comprises:
detecting a selection of a portion of the first item of digital multimedia content that includes video content received from the first viewing position;
displaying a subset of the plurality of frames, wherein the subset corresponds to the portion of the first item of digital multimedia content that includes video content received from the first viewing position; and
displaying a plurality of audio objects, each of which represents a portion of a first audio component that is synchronized with the portion of the first item of digital multimedia content that includes video content received from the first viewing position.
